(19) United States
(12) Patent Application Publication
(10) Pub. No.: US 2021/0071700 A1
(43) Pub. Date: Mar. 11, 2021

(54) STRUCTURE COUPLING SYSTEM

(71) Applicant: KETER LUXEMBOURG SARL, Niedercorn (LU)

(72) Inventors: Matteo ZANETTE, Venezia (IT); Edoardo FRACCARO, Treviso (IT); Giuseppe ROBERTI, Padova (IT)

(73) Assignees: KETER LUXEMBOURG SARL, Niedercorn (LU); KETER PLASTIC LTD., Herzelyia (IL)

(21) Appl. No.: 16/965,967

(22) PCT Filed: Jan. 23, 2019
(86) PCT No.: PCT/IL2019/050094

§ 371 Date: Jul. 29, 2020

(30) Foreign Application Priority Data
Jan. 30, 2018 (IL) 257253
Jun. 19, 2018 (IL) 260157

(51) Int. Cl. F16B 12/24; A47B 96/14; A47B 47/04; F16B 12/26

(52) U.S. Cl. CPC F16B 12/24; A47B 96/1433; F16B 2012/403; F16B 12/26; A47B 47/045

(57) ABSTRACT

Provided is a coupling system comprises a first tubular member with a top end and a second tubular member with a bottom end, defining together a longitudinal axis. One of the top end of the first tubular member and the bottom end of the second tubular member is configured with a longitudinal axially extending socket portion. The other one of the top end of the first tubular member and the bottom end of the second tubular member is configured with a longitudinal axially extending plug portion for coaxial snug receipt within the socket portion. Each tubular socket portion and the plug portion is configured with a lock opening intersecting the longitudinal axis. The coupling system includes a locking plug configured for locking engagement of the lock openings while in register with one another, thereby preventing axial or rotary displacement of the first tubular member and the second tubular member.

### TECHNOLOGICAL FIELD

The present disclosure is concerned with coupling systems. More specifically the disclosure is directed to coupling of two coaxially disposed elements with a possible branching off member. The disclosure is further concerned with a method for assembling a structure using a coupling according to the disclosure. The disclosure is further concerned with a coupling between a lateral support and a lateral surface, and a method of assembly thereof.

### BACKGROUND ART

References considered to be relevant as background to the presently disclosed subject matter are listed below:
U.S. Pat. No. 3,851,601
U.S. Pat. No. 7,850,021
EP1504694
WO05057026
CN201139304

Acknowledgement of the above references herein is not to be inferred as meaning that these are in any way relevant to the patentability of the presently disclosed subject matter.

### BACKGROUND

U.S. Pat. No. 3,851,601 is concerned with a stand for supporting a shelf holding a variety of articles intended to be displayed for public viewing. The display stand includes a modular framework having upright corner posts supporting releasable side rails that detachably retain a shelf panel. Each framework corner post consists of a plurality of extensions coupled at their opposing ends by a corner joint having a cylindrical body carrying laterally directed projections insertably receivable into openings provided in the terminating ends of the shelf panel supporting rails. The opposing ends of the framework post extensions carry interlocking couplings for snap locking the extensions together so as to capture and hold the corner joint in position whereby a unitary framework is produced.

U.S. Pat. No. 7,850,021 discloses an iron pipe furniture assembly structure that employs a pipe connector as a connection construction component for connecting a supporting shaft and a pipe element. The assembly utilizes an elongated round-shaped fastening shaft of the pipe connector for connecting the pipe element. The pipe element is connected to the fastening shaft via an insertion cork of the pipe element. Embedded ribs on the insertion cork engage embedded grooves on the fastening shaft to secure the pipe element to the pipe connector. A tool engages a groove in the pipe element to rotate the pipe element to cause the embedded ribs to engage and disengage with the embedded grooves.

EP1504694 discloses a structure device that includes a number of couplers each having a vertical barrel to receive ends of vertical ducts, and one or more arms extending from the vertical barrel to engage into horizontal conduits. Each of the horizontal conduits includes one or more ears engaged into lock notches via channels of the arms, when the horizontal conduits are rotated relative to the arms, so as to couple the horizontal conduits and the vertical ducts without additional fasteners or tools. One or more covers may have two angle members attached to two corner portions and rotatably engaged into the arms with axles, to rotatably secure the cover to the couplers.

WO05057026 discloses a corner joint for a framed structure that includes a socket with at least one opening and one transverse member having at least one substantially L-shaped hook means. The hook means is adapted to engage the opening of said socket by being inserted into the opening and subsequently displaced in a first axial direction in relation to the socket. The free end of the substantially L-shaped hook means is thus made to abut the inner face of the socket. The corner joint further includes a post member adapted to be inserted into said socket in the first axial direction. The corner joint is provided with an abutment face for abutment with a portion of the hook means positioned opposite the free end of the hook means, and the socket may be secured to the post member by a fastening means.

CN201139304Y is a utility model disclosing a metal storage rack connector, which comprises a first pipe column, and a second pipe column one end part of which is arranged on the first pipe column. Two end parts of the first pipe column are respectively provided with a first insertion part and a second insertion part for the insertion of a metal storage rack, the other end part of the second pipe column is provided with a third insertion part for the insertion or the sleeve joint of the metal storage rack, the side wall of the first insertion part is provided with a first screw hole communicated with the side wall, and the side wall of the third insertion part is provided with a second screw hole communicated with the side wall. Pipe fittings can be assembled and installed through inserting pipes or rods directly into the insertion parts or sheathing the pipes on the pipe columns, the mounting and the dismounting of the pipe fittings are convenient and fast.

### GENERAL DESCRIPTION

The present disclosure provides a coaxial joint system for coaxially articulating a first axial member to a second axial member along a longitudinal axis, with optional one or more side beams branching off from at least one of the first and second axial members in a direction away from the longitudinal axis.

According to a first aspect of the present disclosure there is provided a coupling system comprising:

a first tubular member with a top end and a second tubular member with a bottom end, defining together a longitudinal axis, wherein one of the top end of the first tubular member and the bottom end of the second tubular member is configured with a longitudinal axially extending socket portion, and the other one of the top end of the first tubular member and the bottom end of the second tubular member is configured with a longitudinal axially extending plug portion for coaxial snug receipt within the socket portion; wherein each of the tubular socket portion and the plug portion is configured with a lock opening intersecting the longitudinal axis; and a locking plug configured for locking engagement of the lock openings while in register with one another, thereby preventing axial or rotary displacement of the first tubular member and the second tubular member.

The terms top end and bottom end are used herein to denote a first end and a second end of coextending, coaxially coupleable, tubular members, regardless of the angular position of the longitudinal axis of the tubular members and whether extending coaxially on top of one another or coaxially below one another.

The locking plug may be configured for substantially concealing the opening formed in the tubular member comprising the socket portion.

At least one of the first and the second tubular members may be configured with one or more laterally extending beams, an axis of which intersects a longitudinal axis of the respective at least one of the first and second tubular members.

The one or more laterally extending beams may be oriented to extend along an axis which is at a right angle or inclined with respect to the longitudinal axis of the respective at least one of the first and second tubular members.

The one or more laterally extending beams may be fixed or detachably attached to the respective at least one of the first and second tubular members.

In an assembled configuration an external surface of the first tubular member and an external surface of the second tubular member may coextend and may be flush with one another.

One of the first tubular member and the second tubular member may be configured with a radially inward annular socket shoulder at a base of tubular socket portion, and the other of the first tubular member and the second tubular member may be configured with a radially inward annular plug shoulder at a base of the plug portion.

The socket shoulder may have an annular width substantially the same as the plug shoulder.

In an assembled configuration the socket shoulder may bear against the plug shoulder, whereby axial loads between the first tubular member and the second tubular member can be transferred.

An external diameter of the first tubular member may be substantially similar to an external diameter of the second tubular member.

At least one of the first and second tubular members may be configured with one or more support arms, laterally extending towards an opposite another at least one respective first or second tubular member.

The plug portion may comprise a male screw thread and the socket portion may comprise a female screw thread. The male and female screw threads facilitate secure connection and alignment between the first and second tubular members.

According to a second aspect of the present disclosure, there is provided a coupling system according to the first aspect, wherein the socket portion is a tubular socket portion, and the plug portion may be a tubular plug portion for coaxial snug receipt within the tubular socket; wherein the system further comprises a bored coupling sleeve member configured for coaxially snugly mounting over the tubular socket, the coupling sleeve member being configured with a lock opening intersecting the longitudinal axis; and the locking plug being configured for locking engagement of the lock openings while in register with one another, thereby preventing axial or rotary displacement of the first tubular member, the second tubular member and the coupling sleeve member.

The locking plug may be configured for substantially concealing the opening formed at the coupling sleeve member.

The coupling sleeve member may be configured with one or more laterally extending beams, an axis of which may intersect a longitudinal axis of the coupling sleeve member.

The one or more laterally extending beams may be oriented to extend along an axis which is at a right angle or inclined with respect to the longitudinal axis of the coupling sleeve member.

The one or more laterally extending beams may be fixed or detachably attached to the coupling sleeve member. For example, the laterally extending beams may be formed integral to or separate from the coupling sleeve member.

An external diameter of the coupling sleeve member may be substantially similar to an external diameter of the second tubular member.

In an assembled configuration an external surface of the first tubular member, an external surface of the coupling sleeve member and an external surface of the second tubular member may coextend and may be flush with one another.

The coupling sleeve member may be longer than both the tubular socket portion and the tubular plug portion.

The first tubular member may be configured with a radially inward annular socket shoulder at a base of tubular socket portion, and the second tubular member may be configured with a radially inward annular plug shoulder at a base of the tubular plug portion.

The socket shoulder may have an annular width substantially the same as the through-thickness of the coupling sleeve member.

The plug shoulder may have an annular width substantially the same as the cumulative through-thickness of the coupling sleeve member and annular width of the socket shoulder.

In an assembled configuration respective ends of the coupling sleeve member may bear against the respective socket shoulder and plug shoulder, whereby axial loads between the first tubular member and the second tubular member are borne by the coupling sleeve member.

An external diameter of the coupling sleeve member may be substantially similar to an external diameter of the first tubular member, at least at a portion adjoining the tubular socket.

An internal diameter of the coupling sleeve member may be substantially similar to an external diameter of the tubular socket of the first tubular member.

The coupling sleeve member may be configured with one or more support arms, laterally extending towards an opposite another coupling sleeve member.

The tubular members and the coupling sleeve member may be configured with a self-aligning arrangement, whereby the members can be co-axially mounted only at one or more predefined angular positions.

A support arm laterally extending from a coupling sleeve member may have an axis of extension which intersects an axis of a locking plug at a right angle or other angle.

A coupling sleeve member can be configured with one or more laterally extending extensions, for articulating a support arm thereto.

The first and second aspects above may comprise any one or more of the following features.

Each first tubular member and each second tubular member may be configured at a top end and at a bottom end with one of a socket portion and a plug portion. Accordingly, a tubular member can have only one end configured with a socket portion or a plug, or a tubular member can have both the top end and the bottom ends configured with a plug, or a socket, i.e. one of each element or the same element at both ends. The socket and plug portions may be tubular, conical, frustoconical or the like. The socket and plug portions may each be one of solid, partially hollow and hollow.

A socket portion and a plug portion disposed at respective ends of a tubular member may extend coaxially or along axes which intersect one another.

The locking plug may be snappingly arrested at its locked position, so as to prevent accidental displacement thereof.

The tubular members may have a round cross section (i.e. circular or oval) or a polygonal cross section.

The tubular members may have a regular cross section, or an irregular cross section, and/or the cross section may change along a longitudinal axis.

The tubular members may be solid, at least partially hollow or hollow.

The locking plug may be press fit into the lock openings.

Indicia can be provided regarding angular positioning of the tubular members respective to one another and alignment of the openings for the locking plug.

Indicia may be provided on at least portions of the socket portion and the plug portion, for ascertaining correct axial positioning with respect to one another;

The system may be modular.

Parts of the system may be interchangeable.

According to a third aspect of the present disclosure, there is provided a structure comprising at least one coupling system according to the first or second aspects.

According to a fourth aspect of the present disclosure, there is provided a furniture unit comprising several first tubular members and several second tubular members.

The furniture unit may further comprising respective several coupling sleeve members.

The furniture unit may further comprise at least one bottom leg member comprising: a top end configured with one of a tubular socket portion and a tubular plug portion; and a bottom, base end piece, comprising a height levelling member.

According to a fifth aspect of the present disclosure, there is provided a method for assembling a structure comprising at least one coupling system according to the first aspect, the method comprising:
a) inserting the tubular plug portion into the tubular socket portion;
b) coaxially rotating the first tubular member and the second tubular member, until the lock openings are in register with one another; and
c) inserting the locking plug into the in-register lock openings so as to prevent axial or rotary displacement of the first tubular member and the second tubular member with respect to one another;
wherein steps a) and b) may be carried out in any order.

According to a sixth aspect of the present disclosure, there is provided a method for assembling a structure comprising at least one coupling system according to the second aspect, the method comprising:
a) mounting the coupling sleeve member over the tubular socket portion;
b) inserting the tubular plug portion into the tubular socket portion;
c) coaxially rotating the first tubular member, the second tubular member and the coupling sleeve member, until the lock openings are in register with one another; and
d) inserting the locking plug into the in-register lock openings so as to prevent axial or rotary displacement of the first tubular member, the second tubular member and the coupling sleeve member with respect to one another.

According to a seventh aspect of the present disclosure, there is provided a lateral surface support structure comprising:

at least one lateral support configured to be detachably attachable to a plurality of lateral projections of a respective plurality of vertical support members, the lateral support comprising predetermined fixing portions to which a lateral surface can be affixed; and

a lateral surface comprising a plurality of fixing portions arranged on the lateral surface at predetermined locations corresponding to the fixing portions on the lateral support;

wherein the lateral surface is configured to be reversibly attachable to the lateral support by the corresponding fixing portions on each of the lateral support and the lateral surface.

The fixing portions on the lateral surface may each comprise: a first clip comprising an engagement portion for engaging the respective fixing portion on the lateral support; and a retaining structure arranged for slideable receipt and retention of the first clip.

At least one of the first clips may be arranged to reversibly lock with the respective retaining structure by means of a snap-fit connection.

The corresponding fixing portions on the lateral surface and the lateral support may comprise at least one of: corresponding protrusions and recesses; corresponding snap-fitting structures; correspondingly contoured surfaces; and correspondingly shaped surfaces.

The lateral surface support structure may comprise a second clip arranged to engage with the first clip by a snap-fitting structure and to retain the lateral support between the first clip and the second clip.

According to an eighth aspect of the present disclosure, there is provided a lateral surface support structure according to the seventh aspect in combination with the plurality of vertical support members comprising the plurality of lateral projections, wherein the at least one lateral support comprises at least one opening passing at least partially therethrough, configured to be aligned with at least one opening passing at least partially through a respective one of the plurality of lateral projections to which the at least one lateral support is arranged to be attached; and

wherein the lateral surface support structure further comprises a locking pin arranged to pass through the openings of the lateral support and the lateral projection when the openings are aligned, thereby locking the lateral support and lateral projection against relative motion, and against rotation in at least two degrees of freedom.

The locking pin may comprise two locking pin portions arranged to attach together in a snap-fitting arrangement so as to retain the lateral support and the lateral projection therebetween.

According to a ninth aspect of the present disclosure, there is provided a furniture unit comprising at least one lateral surface support structure according to the seventh aspect and the plurality of vertical support members comprising the plurality of lateral projections.

According to a tenth aspect of the present disclosure, there is provided a method for assembling a structure comprising at least one lateral surface support structure according to the seventh aspect and a plurality of vertical support members comprising a respective plurality of lateral projections, the method comprising for each lateral surface:
a) attaching the lateral support to multiple of the lateral projections; and
b) attaching the lateral surface to the lateral support with the corresponding fixing portions on each of the lateral support and the lateral surface.

According to an eleventh aspect of the present disclosure, there is provided a wall coupler for mounting a furniture unit to a wall, the wall coupler comprising:

a furniture fixing portion configured to securely embrace a leg or a furniture item; and

a wall fixing portion;

wherein at least one of the furniture fixing portion and the wall fixing portion comprises resilient engagement arrangement for reversibly engaging with the other of the furniture fixing portion with the wall fixing portion.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a modular wash basin according to an example of the present disclosure;

FIG. 2A is an enlarged view of the portion marked A in FIG. 1;

FIG. 2B is an exploded view of FIG. 2A;

FIG. 2C is a perspective longitudinal section of the portion marked D in FIG. 2B;

FIG. 2D is a planar view of the portion marked D in FIG. 2B;

FIG. 2E is an enlargement of the portion marked E in FIG. 2C;

FIG. 2F is an enlargement of the portion marked E in FIG. 2C, viewed in the direction of arrow F;

FIG. 3 is an enlargement of the portion marked 3 in FIG. 2C;

FIG. 4A is a perspective view of a modular cabinet configured according to an example of the present disclosure;

FIG. 4B is a partially exploded view of FIG. 4A;

FIG. 4C is an enlarged sectioned view at plane 4C-4C of FIG. 4B; and

FIG. 5A is a perspective view of a modular shelving system according to an example of the present disclosure;

FIG. 5B is a planar view of a section along plane 5B in FIG. 5A;

FIG. 5C is a perspective view of the section of FIG. 5B;

FIGS. 5D and 5E are perspective views of various modular articles according to examples of the present disclosure;

FIG. 6A is a perspective view of a modular shelving system according to an example of the present disclosure;

FIG. 6B is a perspective view of the modular shelving system of FIG. 6A having the top shelf and shelf connection fittings removed;

FIG. 6C is an exploded partial perspective view of a joint arrangement for all four extremities of the support arm and for the upright supports near the top of the modular shelving system of FIG. 6A;

FIG. 6D is an enlargement of the portion marked AA in FIG. 6C;

FIG. 6E is an exploded partial perspective view of a joint arrangement for all four extremities of the support arm and for the upright supports near the vertical center of the modular shelving system of FIG. 6A;

FIG. 6F is an enlargement of the portion marked BB in FIG. 6E;

FIG. 7A is an exploded perspective underneath view of a shelf connection arrangement for the top shelf of the modular shelving system of FIG. 6A;

FIG. 7B is a perspective view of the underside of the shelf of FIG. 7A;

FIG. 7C is an enlargement of the portion marked CC in FIG. 7B;

FIG. 7D is an enlargement of the portion marked DD in FIG. 7B;

FIG. 7E is a perspective view of a side-clip of FIG. 7A;

FIG. 7F is a front-view of the side-clip of FIG. 7E when viewed in the direction of the arrow A₁;

FIG. 7G is a side-view of the side-clip of FIG. 7E when viewed in the direction of the arrow A₂;

FIG. 7H is a perspective view of a center-clip of FIG. 7A;

FIG. 7I is a side-view of the center-clip of FIG. 7H when viewed in the direction of the arrow A₃;

FIG. 8A is a perspective view of a modular shelving system according to an example of the present disclosure;

FIG. 8B is a perspective view of a modular shelving system according to an example of the present disclosure;

FIG. 8C is a perspective view of the modular shelving system of FIG. 8B with the top two levels of shelves removed to show the shelf support structure;

FIG. 8D is a perspective view of a modular shelving system according to an example of the present disclosure;

FIG. 8E is a perspective view of a modular shelving system according to an example of the present disclosure;

FIGS. 8F, 8G and 8H are perspective views of various modular articles according to examples of the present disclosure;

FIG. 9A is a perspective view of a joint arrangement for two tubular members before the tubular members have been joined together;

FIG. 9B is a cross-sectional view of the joint arrangement of FIG. 9A, taken along the plane 9B-9B in FIG. 9A;

FIG. 9C is a cross-sectional view of the joint arrangement of FIG. 9A, taken along the plane 9C-9C in FIG. 9A, after the tubular members have been joined together;

FIG. 10A is a perspective view of a wall coupler comprising a furniture fixing portion and a wall fixing portion, shown separated;

FIG. 10B is a perspective view of the wall fixing portion of FIG. 10A from the direction of arrow A₄ in FIG. 10A;

FIG. 10C is a perspective view of the wall coupler of FIG. 10A, with the furniture fixing portion and the wall fixing portion shown joined together;

FIGS. 11A and 11B are exploded partial perspective view of a joint arrangement between two tubular leg portions and a locking pin arrangement viewed from opposite directions;

FIG. 11C is an exploded partial perspective view of a part of the locking pin arrangement shown in FIGS. 11A and 11B;

FIG. 11D is an exploded partial perspective view of the two tubular leg portions shown in FIGS. 11A and 11B;

FIG. 12A shows in a perspective partial view an assembly of a leg, a lateral support and a locking arrangement;

FIG. 12B shows in an exploded perspective view the assembly of FIG. 12A;

FIG. 12C shows an enlarged view of a portion of the lateral support of FIG. 12B;

FIGS. 12D and 12E are exploded partial perspective view of the locking arrangement of FIG. 12B;

FIG. 13A is an exploded perspective underneath view of a shelf connection arrangement to a lateral support, comprising a shelf having protrusions, lateral support and first and second clip portions;

FIG. 13B is an enlarged perspective view of one of the protrusions of FIG. 13A;

FIG. 13C is an enlarged perspective view of one of the first clip portions of FIG. 13A;

FIG. 13D is an enlarged perspective view of one of the second clip portions of FIG. 13A;

FIG. 13E is an enlarged perspective view of a connection arrangement between the lateral support, one of the first and one of the second clip portions of FIG. 13A, with the shelf and protrusions thereof not shown;

FIG. 14A is a perspective view of an unlocking device; and

FIGS. 14B-14E show the unlocking device of FIG. 14A being used to separate the first and second clip portions shown in FIGS. 13A-13E.

### DETAILED DESCRIPTION OF EMBODIMENTS

Attention is directed first to FIG. 1 of the drawings, illustrating a modular wash basin unit according to an example of the present disclosure, generally designated 10, and substantially made of injected plastic material.

The modular wash basin unit 10 comprises four legs 12 with two layers of horizontal X-like supports 16 and 18, diagonally extending from the respective legs 12, and configured for reinforcing the wash basin unit 10 and for supporting a drawer/storage compartment 22 and a top surface 26 configured with a sink 28, a faucet 32 and a side surface 36. A towel rack 38 projects at a top portion of the front right leg 12, horizontally extending. It is appreciated that such a towel rack (or other laterally extending accessory) can extend from any leg member of the assembly.

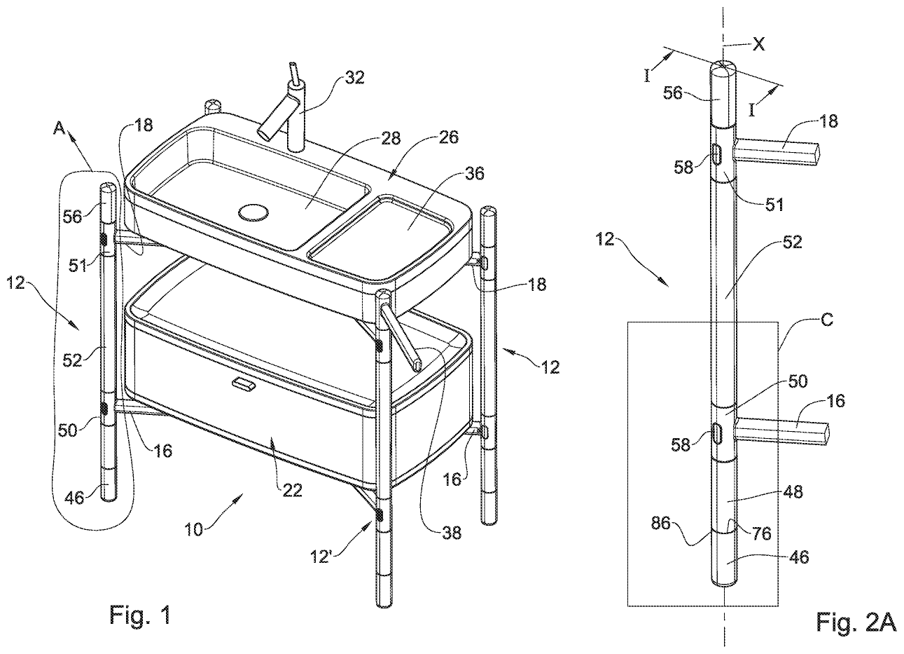

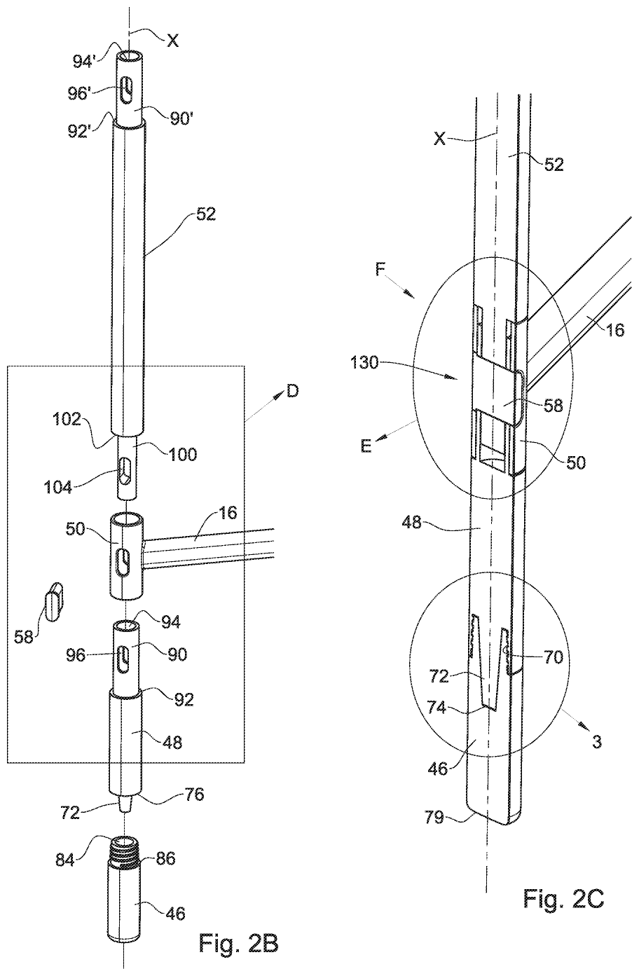

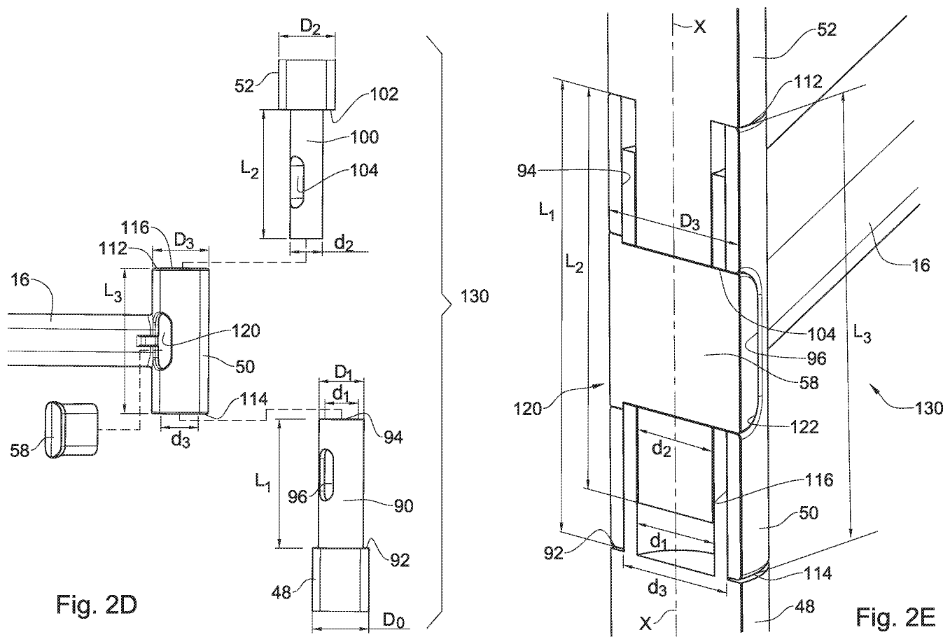

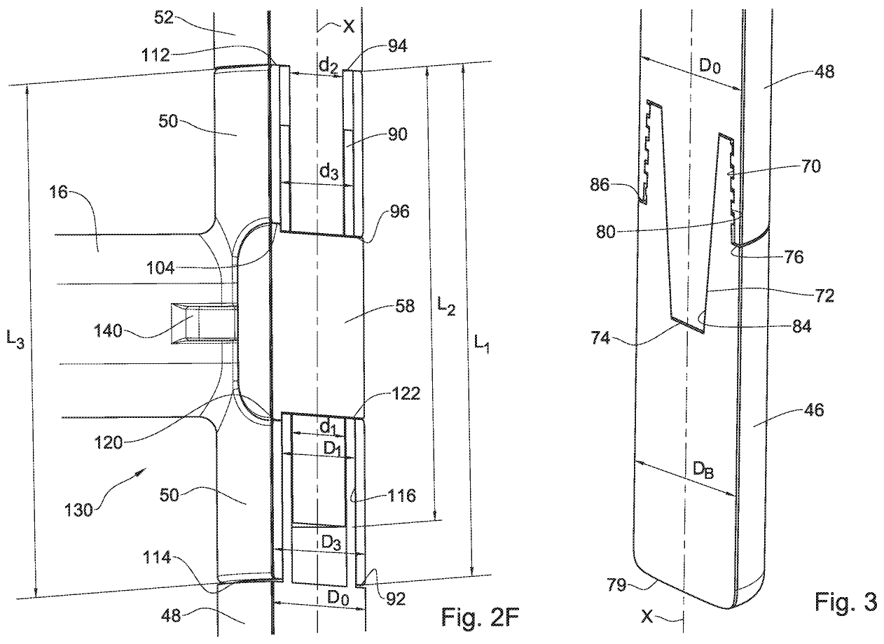

Further reference is now made to FIGS. 2A to 2F of the drawings. It is seen that in the illustrated example each leg 12, extends along a longitudinal axis X, and comprises (from bottom to top) a floor engaging bottom piece 46 capable of providing axial leveling as will be discussed hereinafter, a first tubular member 48, a first coupling sleeve member 50 from which integrally laterally/diagonally extends a bottom support 16, a second tubular member 52, a second coupling sleeve member 51 (similar to the first coupling sleeve member 50 and from which integrally laterally/diagonally extends a bottom support 18), and a top end piece 56. A locking plug 58 is noticeable too, secured with the respective coupling sleeve members 50, 51 as will be discussed hereinafter in greater detail.

Whilst in the annexed drawings the tubular members have a round cross section, i.e. circular, the cross section can be of any shape, e.g. oval, or polygonal. Moreover, the tubular members can have a regular cross section, or an irregular cross section, or the cross section can change along a longitudinal axis, and the tubular members can be solid or hollow.

The first tubular member 48 comprises at a bottom end thereof (best seen in FIG. 3) an internal threaded portion 70 and a tapering projection 72 having a bottom end extending below an annular bottom end 76 of the first tubular member 48. In turn, the bottom piece 46, comprises a floor base 79, an externally threaded neck portion 80 for screw coupling with the internal threaded portion 70 of the first tubular member 48, a tapering cavity 84 configured for receiving the tapering projection 72, and an annular shoulder 86, which at a fully threaded position bears against the corresponding annular bottom end 76 of the first tubular member 48. The threaded coupling 70, 80 facilitates screw coupling thereto the bottom piece 46 and height adjustment for leveling of the furniture piece, in this case wash basin unit 10, by screwing in or out, as may be the need. The first tubular member 48 has an external diameter D_{O} and the bottom piece 46 has an external diameter D_{B}, being substantially similar (D_{O}≈D_{B}).

Coaxially configured at a top end of the first tubular member 48, there is a tubular socket portion 90 defining an annular seat shoulder 92 and configured with an inside bore 94, having a lock opening 96. The tubular socket portion 90 is cylindrical with straight walls and has an external diameter D₁, an internal diameter d₁ and a length L₁.

The second tubular member 52 is configured at a bottom end thereof with a tubular plug portion 100 projecting therefrom and defining an annular seat shoulder 102, having a lock opening 104 of similar shape and size as lock opening 96 of the tubular socket portion 90. The tubular plug portion 100 is cylindrical with straight walls and has an external diameter D₂, an internal diameter d₂ and a length L₂.

The arrangement is such that the following ratios exist between the components:

D_{O}=D₂;d₁=d₂; and L₂<L₁

The coupling sleeve member 50 is a tubular cylindrical member, configured with a top shoulder 112, a bottom shoulder 114 and a central bore 116 having straight side walls with an internal diameter d₃, an external diameter D₃, and an overall length L₃. Further, the coupling sleeve member 50 is configured with a lock opening having a stepped insertion opening 120 and an opposite opening 122, the latter being of similar shape and size as lock openings 96 and 104 of the tubular socket portion 90 and tubular plug portion 100.

The arrangement is such that the following ratios exist between the components:

D_{O}=D₃=D₂;d₃=D₁; and L₃≥L₁

Assembly of the coupling generally designated 130, is facilitated by the following steps:

First, the coupling sleeve member 50 is mounted over the tubular socket portion 90 of the first tubular member 48. Then, the tubular plug portion 100 of second tubular member 52 is inserted into the inside bore 94 of the first tubular member 48. Then, the three members are axially pressed such that bottom shoulder 114 of the coupling sleeve member 50 bears against the annular seat shoulder 92 of the first tubular member 48, and the annular seat shoulder 102 of the second tubular member 52 bears against the top shoulder 112 of the coupling sleeve member 50, such that axially extending forces are borne by said shoulder members and are directed from one element to a consecutive element, and finally to the supporting floor. Once positioned, the three components may require to be slightly rotated about the coaxial longitudinal axis X until the three lock openings 96, 104 and 120/122 are coaxial and in register with one another, wherein the locking plug 58 is inserted, intersecting the longitudinal axis X and snap locking into place at the stepped opening 120. Once the locking plug 58 is positioned in place, the first tubular member 48, the second tubular member 52 and the coupling sleeve member 50 become arrested, whereby axial or rotary displacement are not possible. As mentioned, the locking plug 58 is snappingly arrested at its locked position, so as to prevent accidental removal or displacement thereof.

Dismantling the coupling assembly 130, takes place in a reverse sequence of operations, first, the locking plug 58 is extracted, possibly by using a tool (not shown) inserted into recess 140 (FIG. 2F). Once locking plug 58 is removed, the first tubular member 48, the second tubular member 52 and the coupling sleeve member 50 are free to be removed.

It is further seen in the drawings that each of the coupling sleeve members 50, 51 is integrally formed with a laterally extending arm portion of the support 16, 18, respectively. In fact, in the illustrated example the bottom support 16 and the top support 18, (identical to one another) are X-like shaped, diagonally extending from the respective legs of the wash basin unit 10, each from a respective coupling sleeve member 50 (or 51 of the top support 18). However, it is appreciated that a coupling sleeve member 50, 51 can be configured with additional, or other, lateral projections.

A second (top) end of the second tubular member 52 is configured with tubular socket portion 90′, similar to the disclosure herein above concerning the first tubular member 48, defining an annular seat shoulder 92′ and configured with an inside bore 94′, having a lock opening 96′. The second coupling sleeve member 51 is identical with the first (lower extending) coupling sleeve member 50, as disclosed hereinbefore, while the top end piece 56 is configured similarly to the first (bottom) end portion of the second tubular member 52. Though not seen, the top end piece 56 comprises at a bottom end thereof a tubular plug portion projecting therefrom and defining an annular seat shoulder, having a lock opening for engagement by a locking plug 58.

As mentioned herein before, the terms top end and bottom end are interchangeable and are used herein to denote a first end and a second end of coextending, coaxially coupleable, tubular members, regardless of the angular position of the longitudinal axis of the tubular members. Thus, a top end can be disposed below a bottom end of a coaxially neighboring tubular member.

It is further appreciated that four legs 12 of the modular wash basin unit 10 are substantially similar to one another; however front right leg 12′ is configured at its top end with the towel rack 38 instead of the simple top end piece 56 discussed hereinbefore.

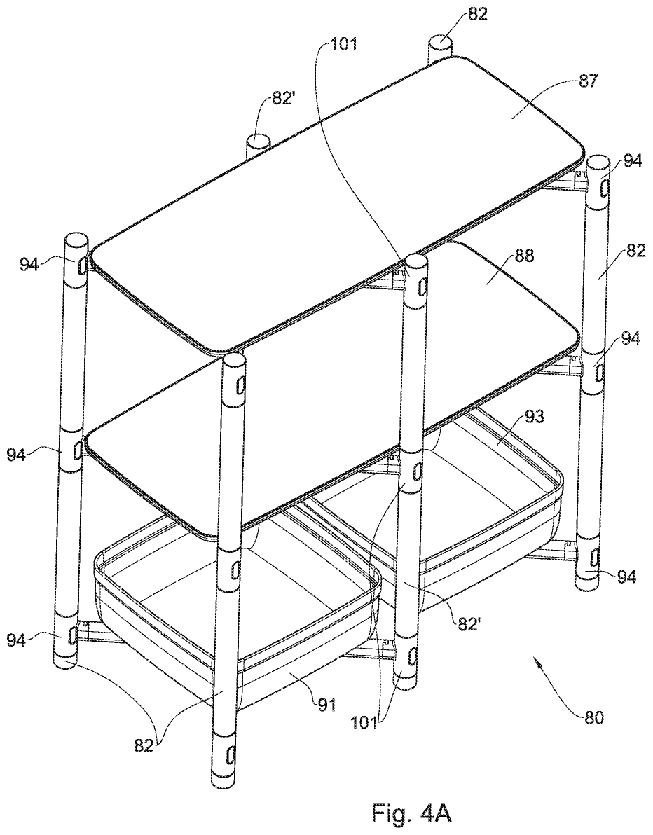

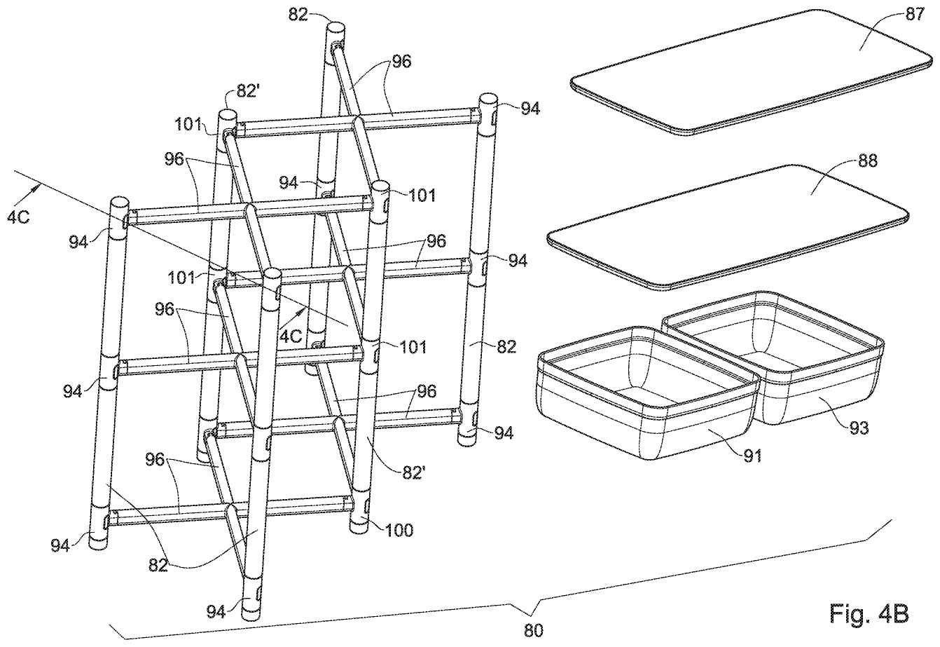

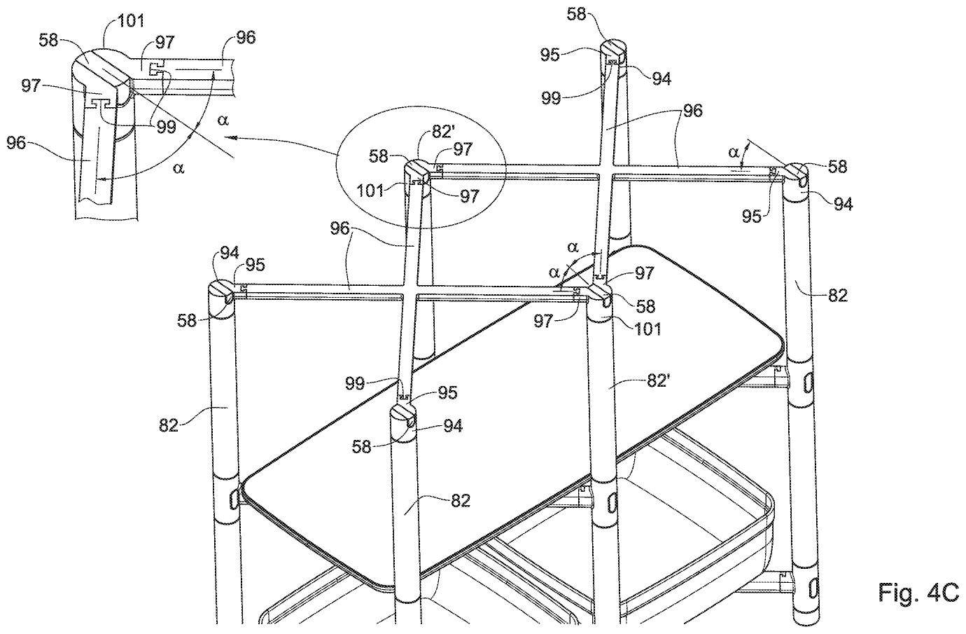

Turning now to FIGS. 4A to 4C there is illustrated a modular cabinet according to another example of the present example, generally designated 80. The cabinet comprises six legs 82, a top shelf 87, an intermediate level shelf 88 and two basket like containers 91 and 93 articulated over respective horizontal diagonally extending support arms 96 extending from the legs 82. The support arms 96 (best seen in FIG. 4B) horizontally and diagonally extend from the respective legs 82, wherein the legs are configured and assembled similarly to the disclosure referring to legs 12 of the modular wash basin unit 10 disclosed herein above, with coaxially extending tubular members interconnected with the coupling sleeve members 94 snugly embracing over the male-female coupling (i.e. plug and socket coupling; not seen).

However, the two center legs 82′ of the modular cabinet 80 are configured with slightly different coupling sleeve members 101, wherein each such coupling sleeve member 101 is configured with two diagonally extending support arms 96 (as opposed to only one support arm associated with each coupling sleeve member 94); however, with the same assembly arrangement as discussed herein.

It is further noted that the coupling sleeve members 94 are each configured with a short lateral projection 95 and coupling sleeve members 101 are each configured with two short lateral projections 97, each of said short lateral projections 95 and 97 configured with a recessed dovetail portion 99 for arresting a corresponding end of the support arms 96. It is seen that the lateral projections 95, 97 extend at an angle α with respect to an insertion line of locking plug 58 (the axial line upon which the plug is inserted into the interlocked coupling sleeve member), wherein α<90°.

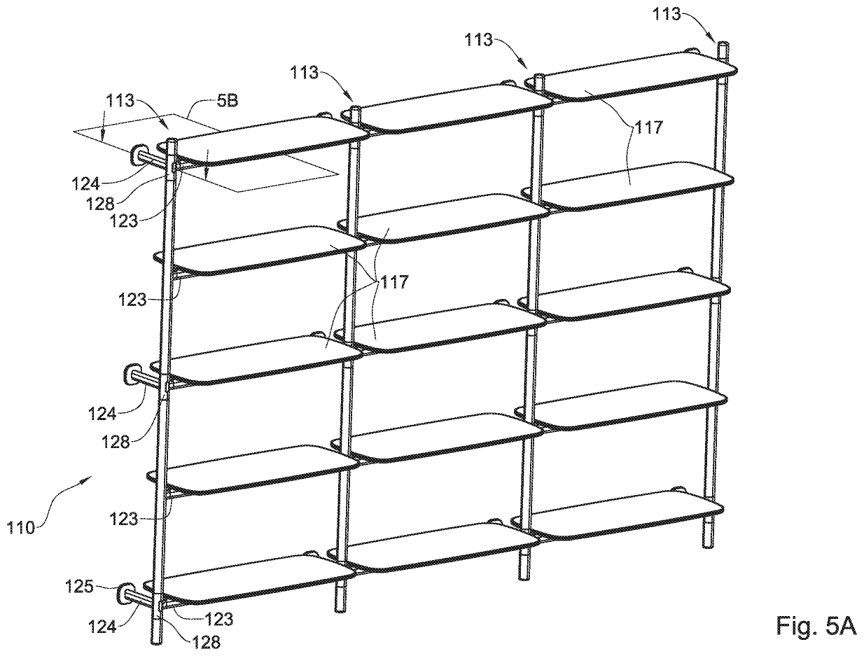

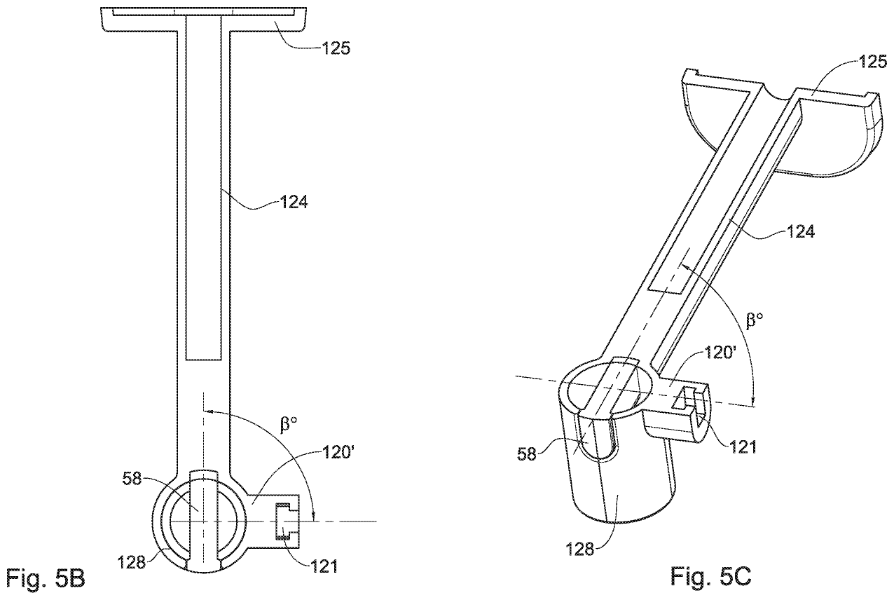

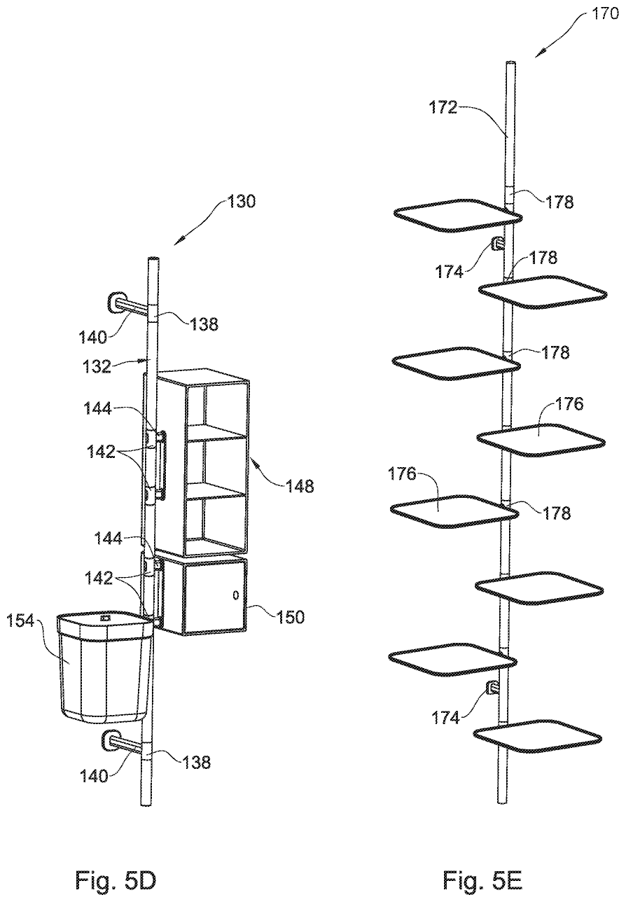

In FIGS. 5A to 5E there are illustrated several other examples of furniture items or furniture units configured in accordance with the present disclosure.

FIG. 5A is directed to a shelving system, e.g. a book shelf system generally designated 110 and comprising four support columns 113 with a plurality of shelves 117 horizontally disposed and supported over support arms 123 extending between neighboring support columns 113 (through respective coupling sleeve members as explained hereinbefore). The columns 113 extend in line, with a single support arm extending below each shelf. The book shelf system 110 is anchored to a support wall (not shown) by wall supports 124, extending from respective top, bottom, and central coupling sleeve members 128 each configured with a support arm 123 and a wall support 124, with a wall mounting plate 125, disposed at a right angle with respect to one another and orthogonally with respect to a longitudinal axis of the support columns 113. It is appreciated that the columns are composed of modular tubular members coaxially interconnected to one another by coupling sleeve members, according to the present disclosure, and wherein assembly of the book shelf is performed in a similar fashion as discussed in connection with the previous examples, whereas the shelves 117 are secured over the support arms 123 by suitable brackets (not shown).

As seen in the sectioned drawings of FIGS. 5B and 5C, the coupling sleeve members 128 are each configured with a short lateral projection 120′, each configured with a recessed dovetail portion 121 for arresting a corresponding end of the support arms 123 (not seen). It is further seen that the lateral projections 120′ extend at a right angle β with respect to an insertion line of locking plug 58 (the axial line upon which the plug is inserted into the interlocked coupling sleeve member), i.e. β=90°.

In FIG. 5D there is illustrated a modular storage system 130 comprising a single column 132, composed in a similar fashion as discussed herein before, namely comprising a plurality of tubular members coaxially interconnected to one another through intermediately disposed coupling sleeve members of which two coupling sleeve members 138 are configured with integral wall mounting arms 140, and four coupling sleeve members 142 are configured with laterally extending support arms 144 which in turn support a top, open shelving unit 148, a closed box-like unit 150 and a suspended bin 154. Assembly of the modular storage system 130 is facilitated according to the same principals as discussed in connection with the previous examples of the present disclosure.

Similarly, the shelving system 170 of FIG. 5E comprises a single column 172, with two wall supports 174, and a plurality of side supported shelves 176, each extending from a respective coupling sleeve member 178, which in turn is disposed between and coaxially supports two coextensive tubular members, as disclosed hereinbefore.

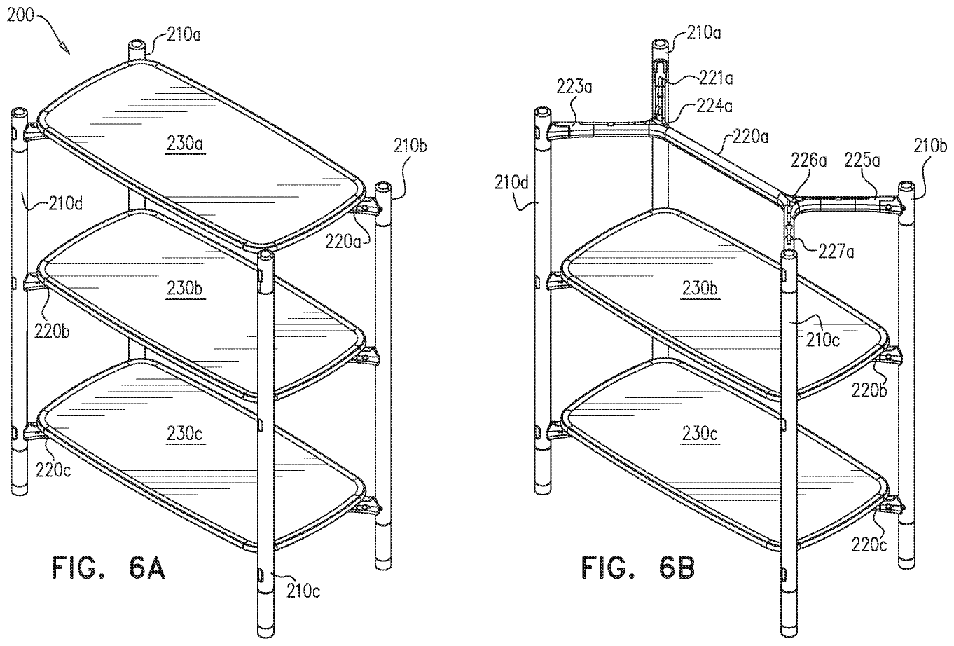

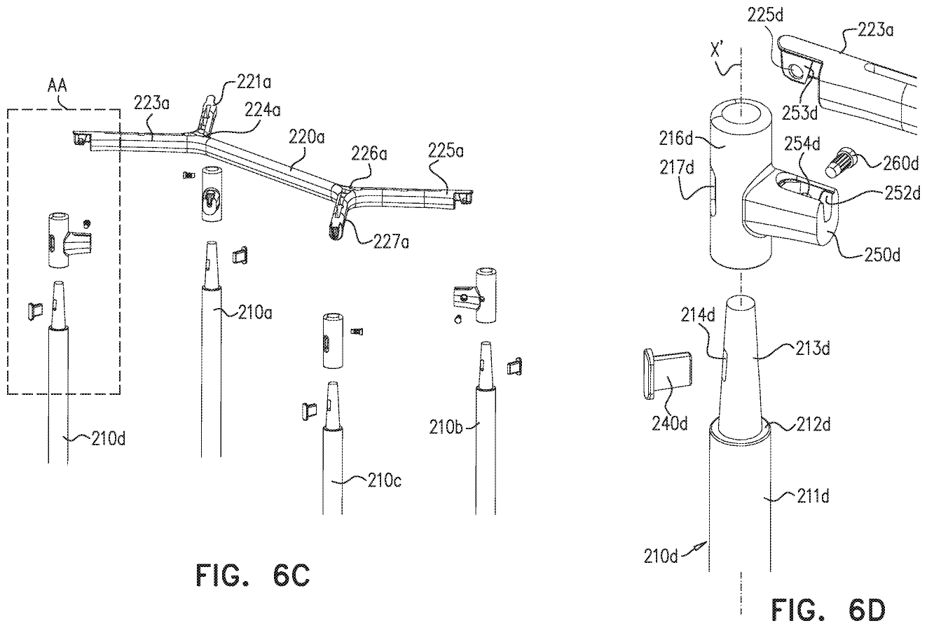

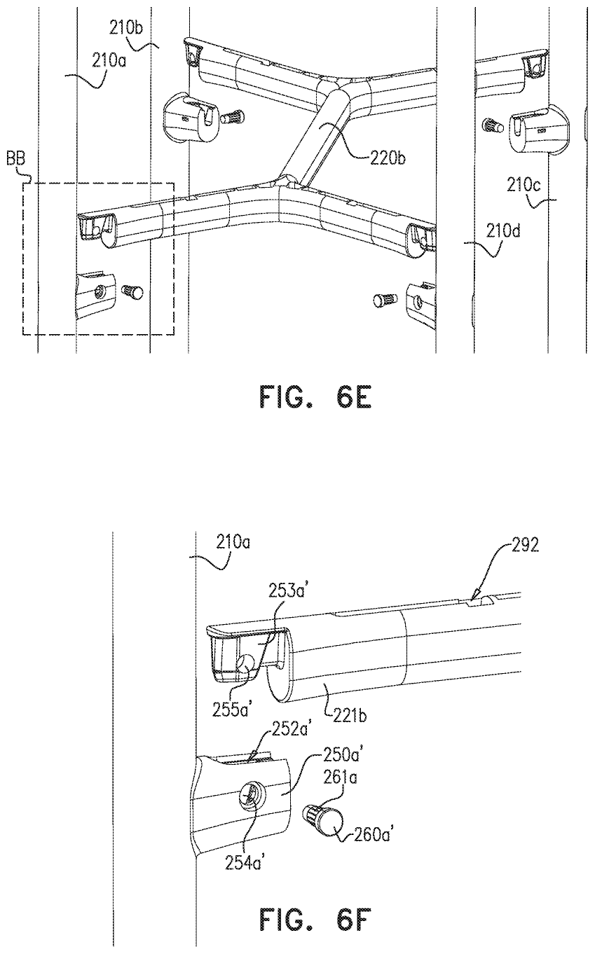

With reference to FIG. 6A, there is shown a shelving system according to an example of the present disclosure, generally designated 200. Shelving system 200 comprises four legs 210a, 210b, 210c, 210d, which are connected to three lateral supports 220a, 220b, 220c. The lateral supports 220a, 220b, 220c are each arranged to support one of three shelves 230a, 230b, 230c via fixings which will be described in more detail below.

FIG. 6B shows the same shelving system 200 with the top shelf 230a removed. As seen in FIG. 6B, the top lateral support 220a comprises a central spar 222a, having two opposing ends 224a, 226a, each of which is forked so as to branch into two beams 221a, 223a, 225a, 227a which can be connected to the legs 210a, 210b, 210c, 210d as will be described in more detail below. These parts can also be seen in the exploded view of FIG. 6C. Although not visible, the other lateral supports 220b, 220c have the same configuration as lateral support 220a. The lateral supports 220a, 220b, 220c function both to provide stability to the shelving system 200 and in order to fixedly support the shelves 230a, 230b, 230c.

FIG. 6D depicts an enlarged exploded view of the portion AA in FIG. 6C.

However, the following description is also relevant to all of the points of connection in the shelving system 200. This shows the connection point near the top of the leg 210d between the portions of the leg 210d and the beam 223a of the lateral support 220a. The leg 210d extends along an axis X′ and comprises a first tubular member 211d having at an axial end surface thereof an outer annular shoulder 212d and an inner frustoconical axially extending protrusion 213d, or plug portion. The frustoconical protrusion 213d has extending at least partially therethrough in a lateral direction a lock opening 214d for engagement of a locking plug 240d as will be described in more detail below.

The leg 210d further comprises second tubular member 216d having a corresponding outer annual shoulder 218d and inner, axially extending conical or frustoconical recess 219d, or socket portion, which face the annular shoulder 212d and frustoconical protrusion 213d of the first tubular member 211d. The second tubular member 216d has extending at least partially therethrough in a lateral direction a lock opening 217d for engagement of the locking plug 240d as will be described in more detail below.

The corresponding frustoconical shapes of the recess 219d and the protrusion 213d allow easy assembly of the tubular members, since the conical shape causes alignment of the tubular members as they are fitted together. In order to assemble each leg, the first and second tubular members 211d, 216d can be mounted to one another by the respective protrusion 213d and recess 219d being fitted together axially. The tubular members 211d, 216d can then be rotated until the locking openings 214d, 217d are aligned with one another. For this purpose, indicia may be provided on the tubular members 211d, 216d which indicate when the two tubular members 211d, 216d are correctly aligned. Once alignment has taken place, the locking plug 240d can be fitted into the lock openings 214d, 217d, thereby connecting the tubular members 211d, 216d together and locking them against relative axial and rotary displacement.

The second tubular member 216d further comprises a short lateral projection 250d protruding laterally in a direction away from the axis X′. The lateral projection 250d comprises a slot 252d for receipt of a correspondingly shaped protrusion 253d of the beam 223a. Each of the lateral projection 250d and the protrusion 253d comprises a respective opening 254d, 255d passing at least partially therethrough for receipt of a locking pin 260d.

To assemble the lateral support 220a to the legs 210a, 210b, 210c, 210d, each of the beams 221a, 223a, 225a, 227a is connected to a respective leg as described for beam 223a herein. The protrusion 253d of the beam 223a is fitted into the slot 252d of the lateral projection 250d, until the opening 254d of the lateral projection 250d and the opening 255d of the protrusion 253d of the beam 223a are aligned. The locking pin 260d is then slotted in a fitting, snug manner into the openings 254d, 255d, locking the beam 223a and the leg 210d together against respective radial and axial movement, and against rotation in at least two degrees of freedom.

A similar arrangement is also shown in FIGS. 6E and 6F. FIG. 6E shows the connections between the lateral support 220b (i.e. the middle lateral support) and the legs 210a, 210b, 210c, 210d. As can be seen, at this connection point, the legs are not formed of two separate tubular members but comprise just a single tubular member. For this reason, there is no need for the protrusion and recess arrangement and locking plug Protruding laterally from each of the legs 210a, 210b, 210c, 210d at a point along the mid-span of each leg 210a, 210b, 210c, 210d is a lateral projection, one of which is shown in more detail as lateral projection 250a′ in FIG. 6F.

FIG. 6F shows leg 210a having a lateral projection 250a′. The lateral projection 250a′ comprises a slot 252a′ for receipt of a protrusion 253a′ which protrudes from the end of the beam 221b of lateral support 220b. The protrusion 253a′ comprises an opening 255a′ passing at least partially therethrough, while the lateral projection 250a′ also has an opening 254a′ passing at least partially therethrough. To assemble the leg 210a and the lateral support 220b, the protrusion 253a′ of the beam 221b is fitted into the slot 252a′ of the lateral projection 250a′, until the openings 255a′, 254a′ are aligned. Once this has been achieved, a locking pin 260a′ is fitted into the openings so as to fix the beam 221b to the leg 210a.

As seen in FIG. 6D, the locking pin 260a′ may be provided with splines 261a′ for a tight, interference fit connection with the inner peripheral surface of the openings 254a′, 255a′. Further, the length of the locking pin 260a′ may be arranged so that the locking pin is flush with an outer surface of the lateral projection 250a′ when fitted into the openings 254a′, 255a′. Thus accidental dislocation of the locking pin 260a′ can be prevented.

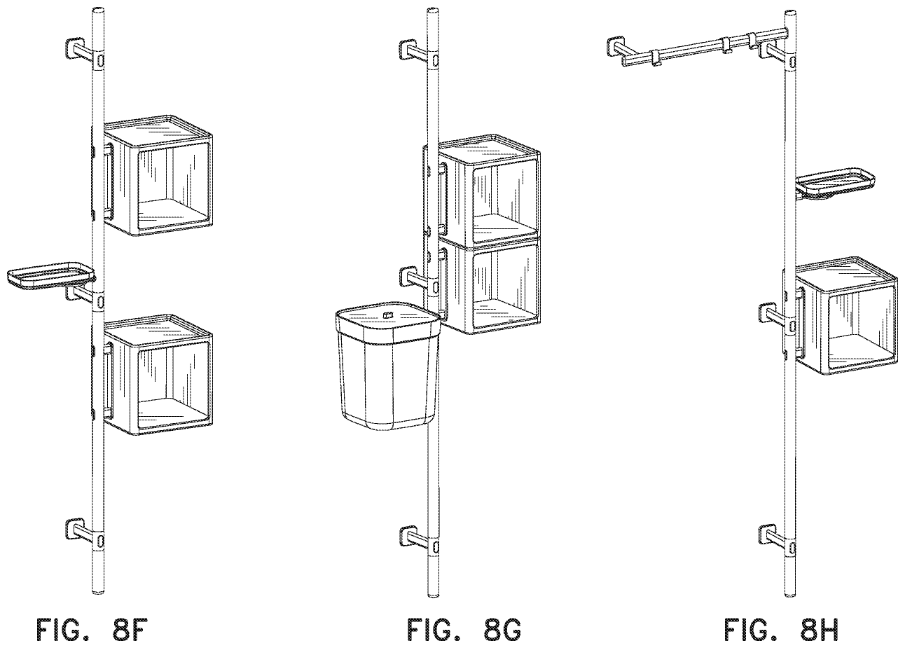

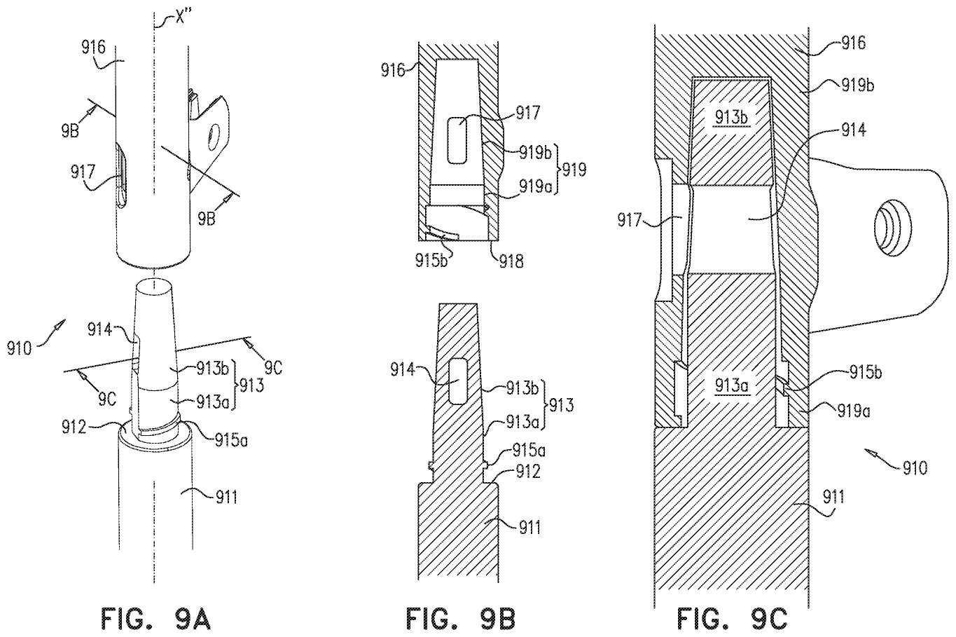

FIGS. 9A-9C shows an alternative arrangement for a leg 910, which is applicable to the legs of any of the previously described embodiments. The leg 910 extends along an axis X″ and comprises a first tubular member 911 having at an axial end surface thereof a radially outer annular shoulder 912 and a radially inner axially extending protrusion 913, or plug portion, in the form of a cylindrical portion 913a followed by a frustoconical portion 913b. The frustoconical portion 913b has extending at least partially therethrough in a lateral direction a lock opening 914 for engagement of a locking plug (not shown), the lock opening and locking plug being the same as those described above, e.g. lock opening 214d and locking plug 240d. The cylindrical portion 913a of the protrusion 913 has disposed thereon a male screw thread 915a. The male screw thread 915a may extend continuously or intermittently. In this particular example, the male screw thread 915a extends intermittently.

The leg 910 further comprises a second tubular member 916 having a corresponding radially outer annual shoulder 918 and inner, axially extending recess 919, or socket portion, in the form of a cylindrical portion 919a followed by a frustoconical portion 919b (see FIG. 9B). The radially outer annual shoulder 918 faces the annular shoulder 912 of the first tubular member 911 and the recess 919 faces the protrusion 913 of the first tubular member 911. The second tubular member 916 has extending at least partially therethrough in a lateral direction a lock opening 917 for engagement of the locking plug (not shown) as described in more detail above. The cylindrical portion 919a of the recess 919 has disposed thereon a female screw thread 915b for engagement with the male screw thread 915a. The female screw thread 915b may extend continuously or intermittently. In this particular example, the female screw thread 915b extends continuously.

The screwing action of the male and female screw threads 915a, 915b enables a secure axial connection and fit between the tubular members 911, 916 of the leg 910, and enable correct rotational fit such that the lock openings 914, 917 are aligned. Thus the screw arrangement 915a, 915b can facilitate ease of correctly fitting together the tubular members 911, 916 to achieve a true alignment, as seen by the alignment of locking openings 914, 917 in FIG. 9C.

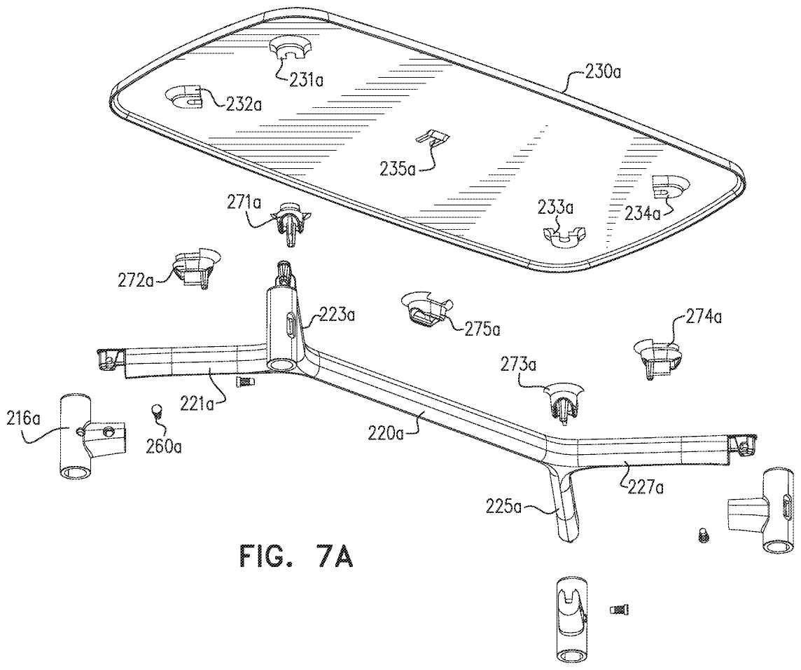

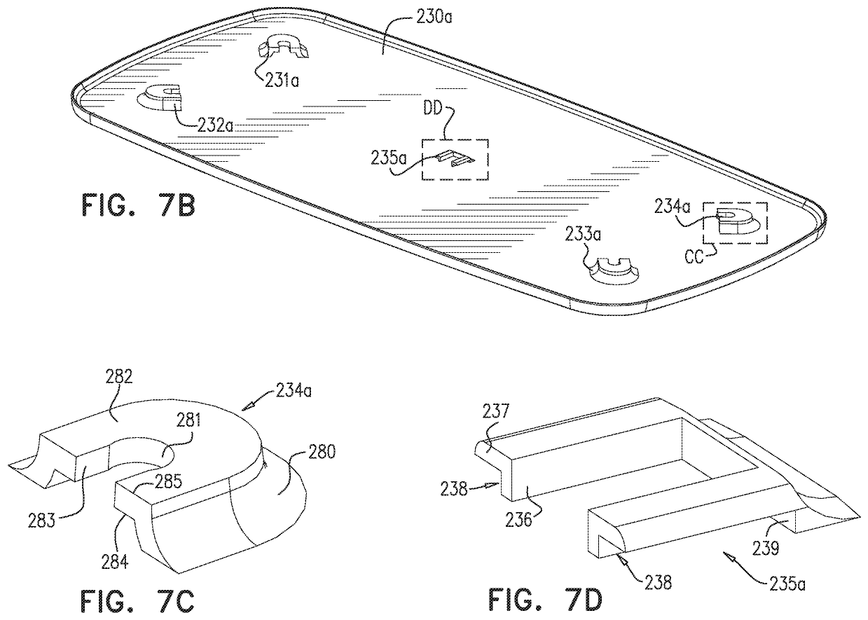

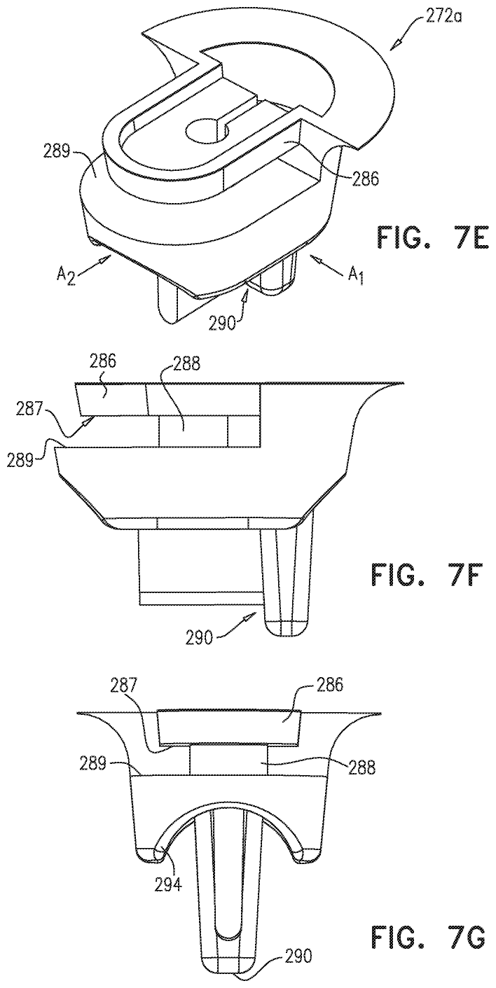

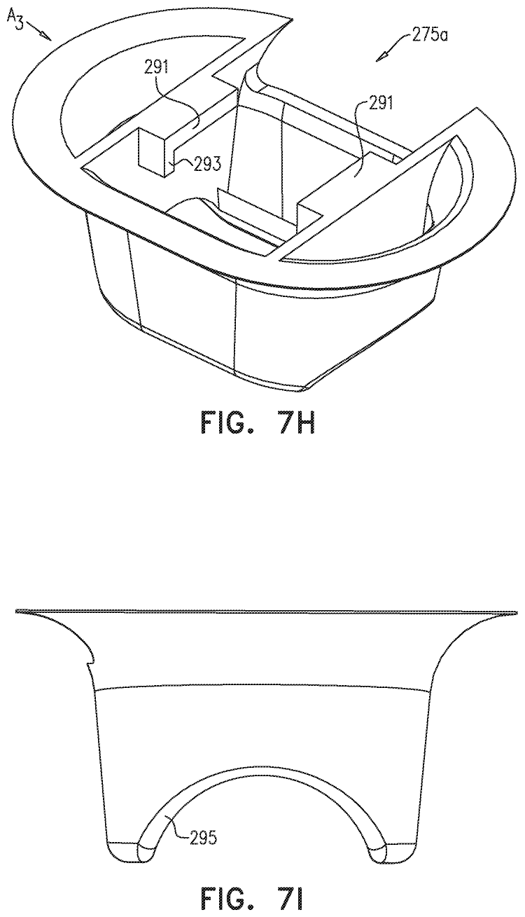

FIGS. 7A-71 depict an exemplary fixing arrangement for fixing a shelf 230a, 230b, 230c to the lateral supports 220a, 220b, 220c. It should be understood that such a fixing arrangement is further applicable to other elements apart from shelves, as long as protrusions for clips (as described below) are provided. Further, some or all of the shelves may be identical to one another, and some or all of the lateral support may be identical to each other.

The present example as described in more detail below provides a lateral surface support structure comprising lateral supports 220a, 220b, 220c, configured to be detachably attachable to the plurality of lateral projections 250 of the respective plurality of legs which are vertical support members. The lateral supports 220a, 220b, 220c are provided with predetermined fixing portions, in the form of apertures and shaped beams and spar 222, to which a lateral surface, i.e. shelf 230 can be affixed. Shelf 230 has a plurality of fixing portions, in the form of protrusions 231a, 232a, 233a, 234a, 235a, with attachable clips 271a, 272a, 273a, 274a, 275a, arranged on the shelf 230 at predetermined locations corresponding to the protrusions on the lateral supports 220a, 220b, 220c. The shelf 230 can be attached to, and subsequently detached from, the lateral support 220a, 220b, 220c by the corresponding fixing portions on each of the lateral support 220 and the shelf 230. This is described in more detail below.

As shown in FIG. 7A, shelf 230a comprises at its underside five protrusions, of which four are located at the sides, i.e. peripheral protrusions 231a, 232a, 233a, 234a, and one is located at the center of the underside, i.e. central protrusion 235a. Each of the protrusions is arranged to retain a respective side clip 271a, 272a, 273a, 274a or central clip 275a capable of attaching to the lateral support 220a. Thus the protrusions are located on the underside of the shelf 230a at positions corresponding to (and directly above, when the shelf 230a is in its fixed position) positions on the lateral support 220a. As can be seen, the central clip 275a is for attachment to the central spar 222a, while the side clips 271a, 272a, 273a, 274a are for attachment to a respective one of the forked beams 223a, 221a, 225a, 227a.

FIG. 7B shows in more detail the underside of the shelf 230a and the five protrusions 231a, 232a, 233a, 234a, 235a thereon. FIG. 7C shows one of the peripheral protrusions 234a enlarged in more detail. The following description of the peripheral protrusion 234a is also applicable to the other peripheral protrusions 231a, 232a, 233a.

As seen in FIGS. 7B and 7C, peripheral protrusion 234a protrudes from the underside of the shelf 230a to form a C-shaped enclosure comprising side walls 280 with a partial cap 282, such that the open edge of the C-shape can receive the peripheral clip 274a in a sliding manner. The peripheral protrusion 234a comprises a retaining structure, provided by the C-shaped side-walls 280 which approach each other in a protrusion direction away from the shelf 230a, and provided further by the cap 282 which caps the side-walls 280 and comprises a C-shaped retaining shoulder 284 for retaining the peripheral clip 274a. A surface of the cap 282 opposite from the retaining shoulder 284 is an outer surface 285 of the cap 282. The cap 282 comprises a circular aperture 281 passing therethrough, i.e. between the shoulder 284 and the outer surface 285, and a slot 283 cut from the open-edge of the C-shaped cap 282 to meet the circular aperture 281. The slot 283 has a width slightly smaller than a diameter of the circular aperture 281.

The peripheral clip 272a, which is identical to clip 274a, is shown in FIGS. 7E, 7F and 7G. The peripheral clip 272a comprises a first portion having a C-shaped side-wall 286 corresponding to the shape of the side-walls 280 of the peripheral protrusions. The first portion of the peripheral clip 272a is for receipt in a recess formed between the underside of the shelf 230a, the side walls 280 and the shoulder 284 of the cap 282. The first portion of the peripheral clip 272a comprises a shoulder 287 for abutting against the shoulder 284 of the cap 282.

The peripheral clip 272a further comprises a second portion for fitting receipt in the slot 283 and circular aperture 281 of the cap 282 of the peripheral protrusion 234, and a third portion for protruding away from the peripheral protrusion 234 towards the lateral support 220. The second portion of the peripheral clip 272a comprises a cylindrical protrusion 288 for locking into the circular aperture 281 of a peripheral protrusion 234. The cylindrical protrusion 288 has a diameter larger than a width of the slot 283, such that once the peripheral clip 272a is slid with some force into the peripheral protrusion 234, the cylindrical protrusion 288 is snap-fittingly engaged with the circular aperture 281, and retained therein by the edges of the slot 283.

The third portion of the peripheral clip 272a comprises an extended protrusion 290, for engagement in a corresponding recess or aperture arranged in the beams of the lateral support, see for example recess 292 shown at least in FIG. 6F. Further, the peripheral surface 294 of the third portion of the peripheral clip 272a which surrounds the extended protrusion 290 is shaped to conform with an outer peripheral surface of the beam of the lateral support, for secure, close-fitting connection thereto and for improved load transfer between the shelf and the lateral support across a larger surface area.

As seen in FIGS. 7B and 7D, central protrusion 235a protrudes from the center of the underside of the shelf 230a and comprises side-walls 236 in the shape of three sides of a square. The two parallel side-walls 236 each comprise at a distal end thereof, i.e. at an end of the sidewall distal from the shelf, an outward-facing flange 237, such that the two flanges 237 project away from the center of the shelf 230a, parallel to the underside of the shelf. The channel 238 formed between the underside of the shelf 230a, the side-walls 236 and the flanges 237 allows for slideable receipt of the central clip 275a, and the central protrusion 235a further comprises an axial stop 239 formed at the end of each channel 238 to limit the sliding movement of the central clip 275a.

The central clip 275a, is shown in FIGS. 7H and 71. The central clip 275a comprises a structure having two parallel L-shaped protrusions, the feet 291 of the L's being for sliding receipt in the parallel channels 238 of the central protrusion, and the legs 293 of the L's providing an axial stop to prevent further ingress of the feet 291 of the L's into the channels 238. The central clip 275a further comprises a distal portion arranged to protrude away from the underside of the shelf 230 when the central clip 275a is connected to the central protrusion 235a. The distal portion comprises a peripheral surface 295 which is shaped to conform with an outer peripheral surface of the spar 222 of the lateral support 220, for secure, close-fitting connection thereto and for improved load transfer between the shelf 230 and the lateral support across a larger surface area.

As can be seen in FIG. 7A, all of the peripheral clips 271a, 272a, 273a, 274a slide into position in a direction parallel to the beam 221a, 223a, 225a, 227a and are placed into a beam aperture 292 for engagement via their extended protrusion 290. Thus, once the shelf 230 is fixed to the beam, the peripheral clips 271a, 272a, 273a, 274a are locked against all relative motion and cannot slide out of place. Similarly, the central clip 275a slides into position in a direction orthogonal to the longitudinal direction of the spar 222. Thus, once the central clip 275a is engaged with the central protrusion 235a, and fitted at its peripheral surface 295 over the spar 222, the central clip 275a is also unable to slide out of place.

Although the above described arrangement is shown as having five protrusions on each shelf, it should be understood that any arrangement of protrusions capable of receiving a clip for attachment to a lateral support is envisioned. Furthermore, should the lateral support comprise a different arrangement other than four branched beams extending from a central spar, the arrangement of protrusions on each shelf can be selected to correspond to the shape of the underlying lateral support.

Moreover, although the above describe specific example refers to a shelf 230, it should be understood that a shelf is just one example of a lateral surface which could be fixed in this manner to the lateral support.

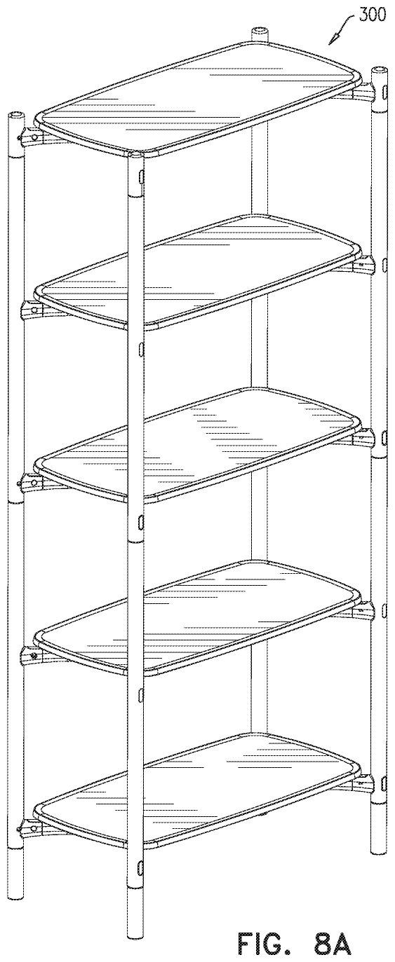

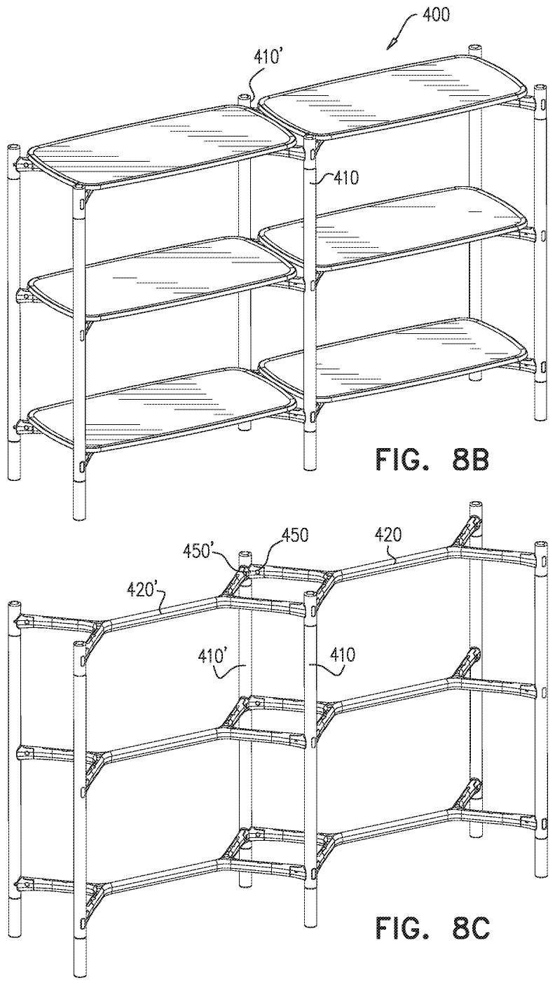

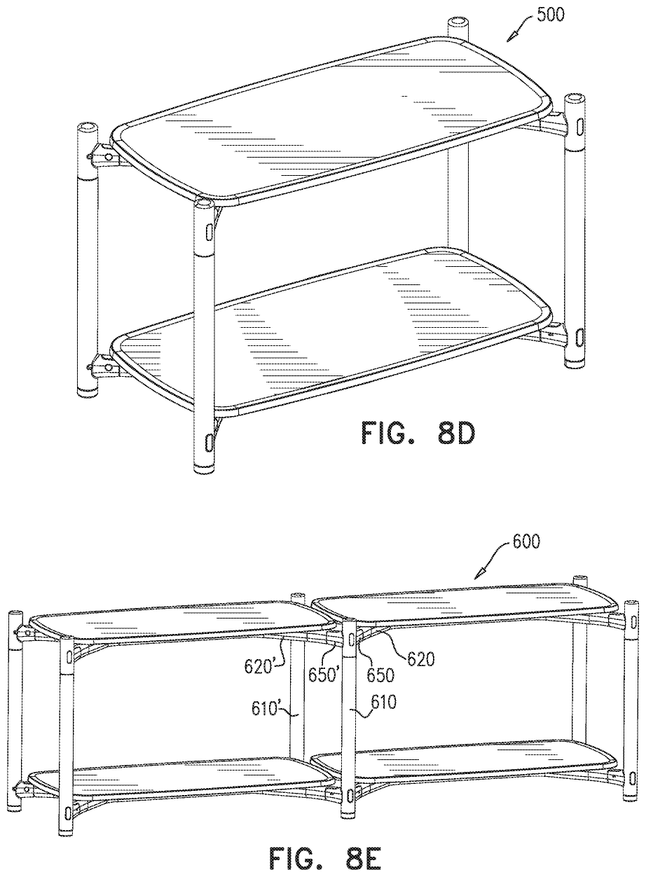

With reference to FIG. 8A, there is shown a shelving system according to an example of the present disclosure, generally designated 300. Shelving system 300 effectively comprises two shelving systems 200 stacked on top of one another and so all of the above description with regard to the shelving system 200 is equally applicable to this example.

With reference to FIGS. 8B and 8C, there is shown a shelving system according to an example of the present disclosure, generally designated 400. Shelving system 400 effectively comprises two shelving systems 200 side-by-side, with the exception that the central legs 410, 410′ are shared legs, such that each is provided with two short lateral projections 450, 450′ at each level, oriented at an angle relative to one another to provide support for the lateral supports 420, 420′ required in each half of the shelving system 400.

With reference to FIG. 8D, there is shown a shelving system according to an example of the present disclosure, generally designated 500. Shelving system 500 effectively comprises a version of shelving systems 200 in which the central shelf supported by the short lateral projection in a mid-span of the legs is absent.

With reference to FIG. 8E, there is shown a shelving system according to an example of the present disclosure, generally designated 600. Shelving system 600 effectively comprises two shelving systems 500 side-by-side, with the exception that the central legs 610, 610′ are shared legs, such that each is provided with two short lateral projections 650, 650′ at each level, oriented at an angle relative to one another to provide support for the lateral supports 620, 620′ required in each half of the shelving system 600.

FIGS. 8F, 8G and 8H depict further exemplary modular systems which may include some or all of the above-described joints and fixings as described in any of the other examples or in the disclosure.

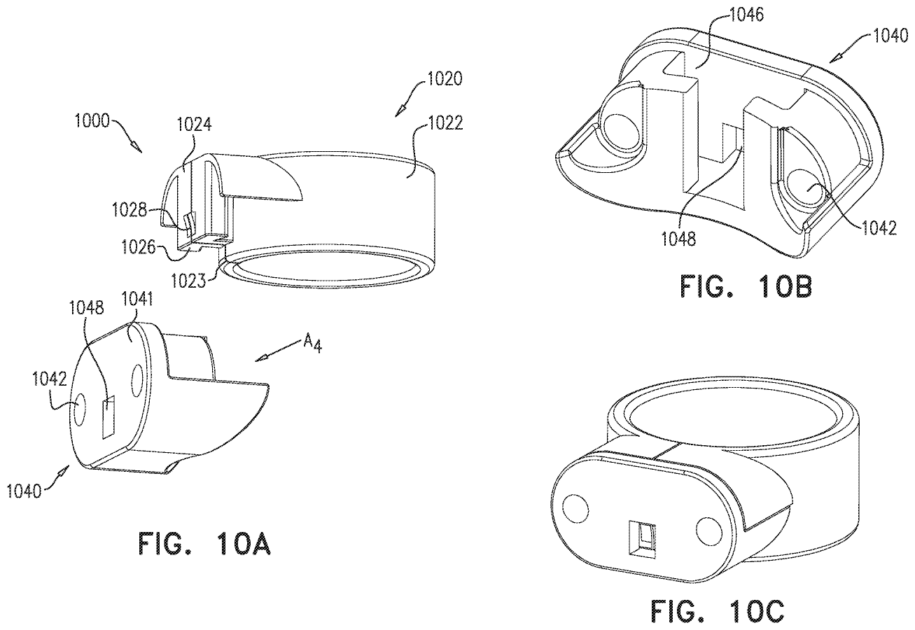

FIGS. 10A-C depict an alternative wall hanger, generally designated 1000, which may be used alternatively or additionally in any of the previously described or depicted embodiments. The wall hanger 1000 may also be known as a wall mount, wall fixing or wall coupler. Wall hanger 1000 comprises a furniture fixing portion 1020 and a wall fixing portion 1040 arranged to reversibly connect to one another. The furniture fixing portion 1020 is for surrounding or supporting a leg, beam, or other component of a furniture unit or system. In this particular example, the furniture fixing portion 1020 comprises a hollow cylindrical ring-portion 1022 for surrounding a leg of a furniture unit, e.g. leg 210 or 910 described above.

The ring-portion 1022 comprises a gap 1023, i.e. it is an incomplete ring. This allows flexibility in the ring-portion to be expanded or compressed as described in more detail below. The furniture fixing portion 1020 also comprises a connector portion 1024 for connecting to the wall fixing portion 1040 as described in more detail below. The connector portion 1024 comprises a shaped protrusion 1026 protruding from the ring-portion 1022 on either side of the gap 1023, e.g. having a dovetail shape as shown, and a resilient engagement arrangement, in the form of a resilient projection 1028.

With reference to both FIGS. 10A and 10B, the wall fixing portion 1040 comprises a wall facing surface 1041 and holes 1042 for fixing the wall fixing portion 1040 to a wall or other mounting surface, with the use of screws, bolts, rivets or other fixing arrangement (not shown). The wall fixing portion 1040 further comprises a shaped recess 1046 having a recess profile or shape corresponding to the profile or shape of the protrusion 1026 of the furniture fixing portion 1020. The shaped recess 1046 is for receiving the correspondingly shaped protrusion 1026. As shown, the recess 1046 and protrusion 1026 take a corresponding dovetail or similar shaped configuration, such that once the protrusion 1026 has been inserted into the recess 1046, the furniture fixing portion 1020 and the wall fixing portion 1040 are held together in a secure fit. Although a dovetail-shaped arrangement is shown, other arrangements are envisaged, which have correspondingly shaped projections and recesses to achieve a secure fit.

The wall fixing portion 1040 further comprises an aperture 1048 for receipt of the resilient projection 1028. It is envisaged that aperture 1048 need not pass through the thickness of the wall fixing portion 1040 but may instead take the form of a recessed portion in a surface of the wall fixing portion 1040.

In use, the wall fixing portion 1040 is mounted to a wall or other mounting surface by the use of screws, bolts, rivets or other fixing arrangement, such that the wall facing surface 1041 faces the wall or other mounting surface. The furniture fixing portion 1020 is slipped or fastened around a tubular member of a furniture leg, e.g. leg 210 or 910 as described above, and the ring-portion 1022 can be expanded by pulling the sides of the ring-portion 1022 away from each other to enlarge the gap 1023, to facilitate easier movement of the ring-portion 1022 over the leg. The sides of the ring portion 1022 can then be pushed towards each other, i.e. compressed, to reduce the size of the gap 1023 in order to tightly embrace the leg. The protrusion 1026 is inserted into the corresponding recess 1046, to achieve a secure fit between the furniture fixing portion 1020 and the wall fixing portion 1040.

As the protrusion 1026 is moved into position inside the recess 1046, the resilient projection 1028 engages in the aperture 1048, to prevent the furniture fixing portion 1020 and the wall fixing portion 1040 from becoming too easily disengaged. In the event that a user wishes to disengage the furniture fixing portion 1020 and the wall fixing portion 1040, enough force will need to be applied in order to disengage the resilient projection 1028 from the aperture 1048. To this end, the resilient projection may comprise a material which can be elastically deformed, may comprise a spring or other deflectable member, and/or may comprise continuous or rounded edges to facilitate engagement and disengagement. In this manner, the furniture fixing portion 1020 and the wall fixing portion 1040 can be securely and reversibly engaged to fasten the furniture unit to a wall or other mounting surface.

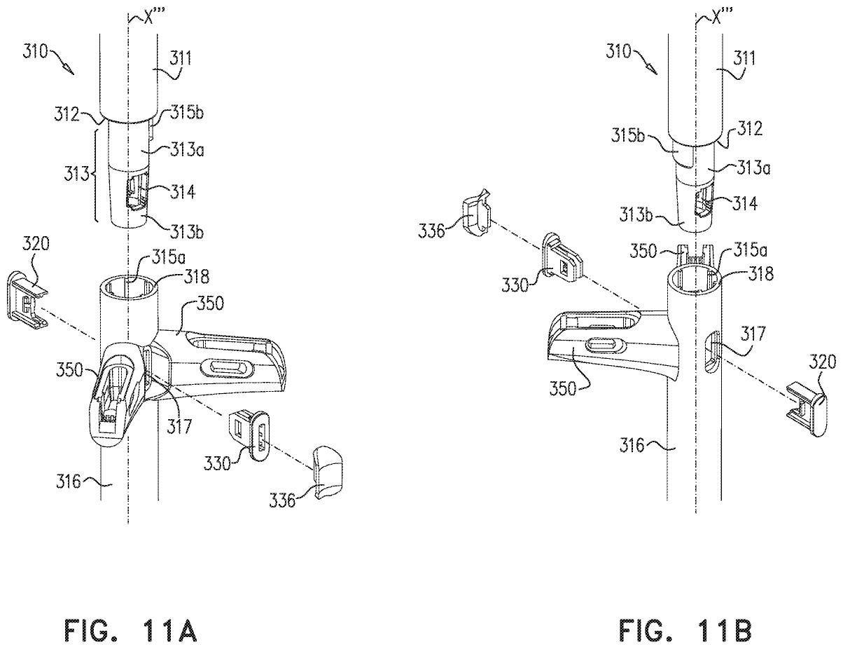

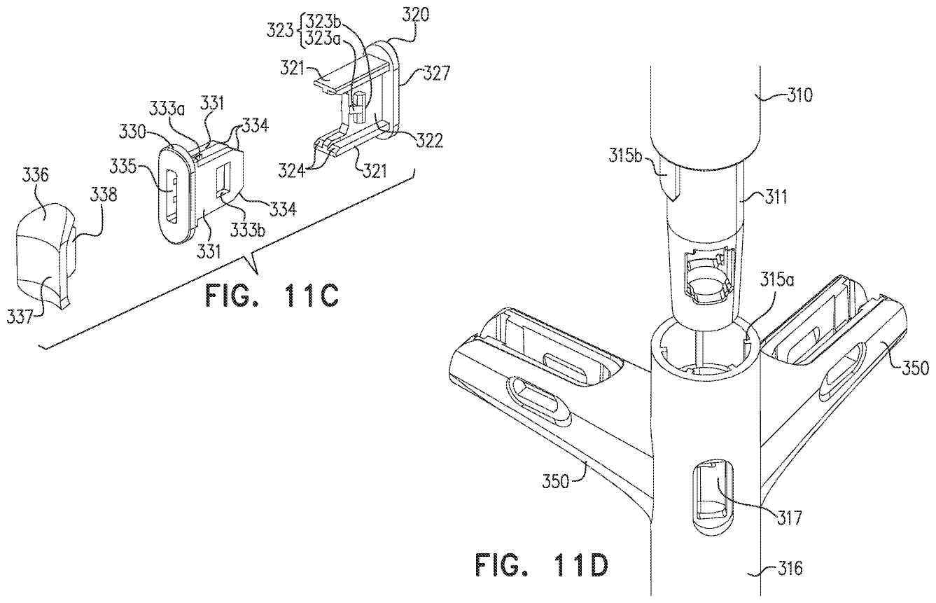

FIGS. 11A-11D shows an alternative arrangement for a leg 310, which is applicable to the legs of any of the previously described embodiments. The leg 310 extends along an axis X′″ and comprises a first tubular member 316 and a second tubular member 311. The second tubular member 311 has at an axial end surface thereof a radially outer annular shoulder 312 and a radially inner axially extending protrusion 313, or plug portion, in the form of a cylindrical portion 313a followed by a frustoconical portion 313b. The frustoconical portion 313b has extending at least partially therethrough in a lateral direction a lock opening 314 for engagement of a locking plug arrangement 320, 330, 336 described below. The cylindrical portion 313a of the protrusion 313 has disposed thereon a protruding portion 315b.

The first tubular member 316 has two short lateral projections 350 projecting radially outwardly from the axis X′″ and in direction transverse to one another so as to form an acute angle therebetween. The first tubular member 316 further comprises a corresponding radially outer annual shoulder 318 and inner, axially extending recess 319, or socket portion, which comprises at a top section thereof axially extending ribs 315a spaced around an inner circumference of the recess 319 and at a deeper section thereof a frustoconical portion arranged to receive the frustoconical portion 313b. The radially outer annual shoulder 318 of the first tubular member 316 faces the annular shoulder 312 of the second tubular member 311, and the recess 319 of the first tubular member 316 faces the protrusion 313 of the second tubular member 311. The first tubular member 316 has extending at least partially therethrough in a lateral direction a lock opening 317 for engagement of the locking plug arrangement 320, 330, 336 described below. The spaces between the axially extending ribs 315a of the recess 319 are arranged to receive and engage the protruding portion 315b, while a radially inner surface of the axially extending ribs 315a ensures a snug fit against the cylindrical portion 313a of the protrusion 313 when assembled.

The slotting together action of the axially extending ribs 315a and the protruding portion 315b enables a secure connection against rotation between the tubular members 311, 316 of the leg 310, and enable correct rotational fit such that the lock openings 314, 317 are aligned. Thus the axially extending ribs 315a and the protruding portion 315b can facilitate ease of correctly fitting together the first and second tubular members 316, 311 to achieve a true alignment.

The locking plug arrangement comprises a first plug portion 320, a second plug portion 330 and a flush surface portion 336. The first plug portion 320 comprises two protruding pin portions 321 in between which is disposed an intermediate portion 322 which protrudes less than the pin portions 321. On either side of the intermediate portion 322 is a snap-fit protrusion 323 comprising a ramp 323a followed by a step 323b. Each of the pin portions 321 comprises a ramped portion 324 at a distal end thereof. An outer surface 327 of the first locking plug portion 320 is arranged to lie flush or slightly recessed with an outer surface of the first tubular member 316 when assembled.

The second plug portion 330 comprises two parallel protruding cantilever portions 331, each comprising an aperture 333b passing therethrough. On a side of each protruding cantilever portion 331 located in between the two parallel cantilever portions 331 are a plurality of ramp portions 333a. Each of the cantilever portions 331 comprises a ramped portion 334 at a distal end thereof. The second plug portion 330 further comprises a slot 335 at an end of the second plug portion 330 away from the distal end.

The flush surface portion 336 comprises a curved surface 337 and a protruding portion 338.

In operation, the first tubular member 316 and the second tubular member 311 of the leg 310 are slotted together, such that the protrusion 315b is fitted into one of the spaces between adjacent ribs 315a, and so that the lock openings 317, 314 of the first and second tubular members 316, 311 are aligned. The first and second locking plug portions 320, 330 are then inserted into the aligned lock openings 314, 317 from opposite directions, such that the second locking plug portion 330 is inserted in the acute angle between the short lateral projections 350, while the first locking plug portion 320 is inserted from the opposite direction, i.e. in the obtuse angle between the short lateral projections 350.

As the first and second locking plug portions 320, 330 are pushed towards one another, the ramp portions 334 of the second locking plug portion 330 contact and slide over the ramp portions 324 of the first locking plug portion 320, and two parallel cantilever portions 331 of the second locking plug portion 330 move parallel to and on either side of the intermediate portion 322 of the first locking plug portion 320. In doing so, the two parallel cantilever portions 331 of the second locking plug portion 330 contact and slide over the ramp portions 323a of the first locking plug portion 320, so that the two parallel cantilever portions 331 of the second locking plug portion 330 are urged away from one another, i.e. wider apart.

After the first and second locking plug portions 320, 330 are pushed towards one another to a pre-set extent, the steps 323b will lock inside the apertures 333b causing the two parallel cantilever portions 331 to move back towards one another. This is a snap-fit arrangement, such that the first and second locking plug portions 320, 330 cannot be disengaged without urging the two cantilever portions 331 apart to release the steps 323b from their respective apertures 333b.

The protruding portion 338 of the flush surface portion 336 can then be fitted into the slot 335 of the second plug portion 330, such that the curved surface 337 lies flush with, or slightly recessed compared to, the outer surface of the first tubular member 316 in the section comprising the acute angle between the short lateral projections 350.

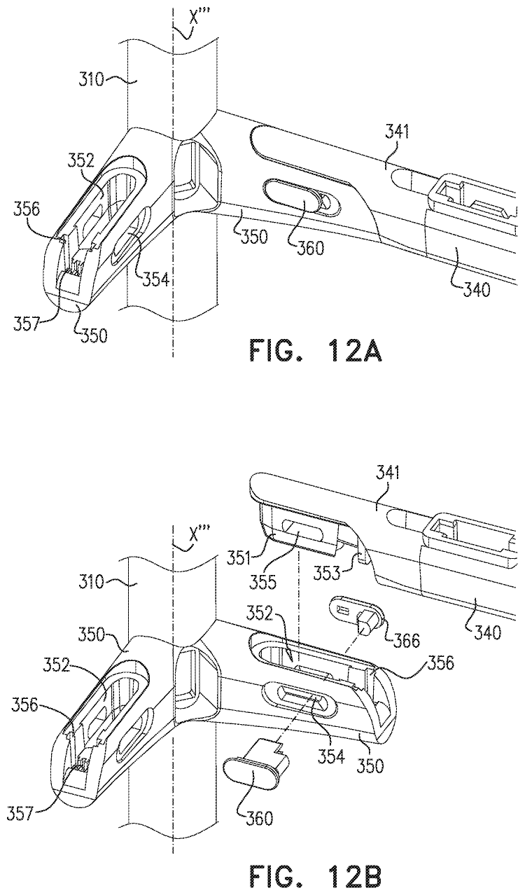

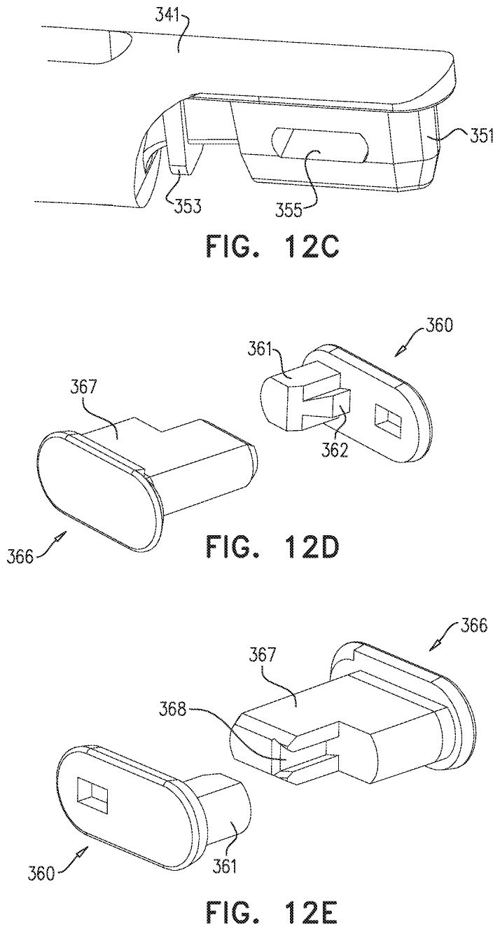

With reference to FIGS. 12A-12E, there is shown an alternative connection arrangement between a leg 310 and a lateral support 340 of a shelving system similar to the arrangement shown with reference to FIGS. 6A-6F. The lateral support 340 comprises a central spar having two opposing ends, each of which is forked so as to branch into two beams 341 which can be connected to the legs 310 as will be described in more detail below.

The first tubular member 316 described above comprises two short lateral projections 350, each protruding laterally in a direction away from the axis X′″. Each lateral projection 350 comprises a main elongate slot 352 for receipt of a correspondingly shaped protrusion 351 of the beam 341 which is a protrusion having a cross-section elongate in a direction parallel to the length of the beam 341. Each lateral projection 350 further comprises a transverse slot 356, arranged to receive a correspondingly shaped protrusion 353 of the beam 341 which has a cross-section elongate which is elongate in a direction transverse to the length of the beam 341.

Each slot 356 comprises a number of teeth 357 arranged on either side of the slot 356, arranged to engage the protrusion 353 of the beam 341 when the protrusion 353 is received in the slot 356.

Each protrusion 351 comprises an opening 355 passing therethrough, arranged to align with an opening 354 passing through the corresponding lateral projection 350 when the protrusion 351 is received in the slot 352. The openings are for receipt of a two-part locking pin 360, 366.

The locking pin comprises a first locking pin portion 360 and a second locking pin portion 366 arranged to be inserted into the aligned openings from opposite directions, i.e. from opposite sides of each lateral projection 350. The first locking pin portion 360 comprises a first engagement portion comprising a dovetail shaped protrusion 362. The second locking pin portion 366 comprises a second engagement portion 367 comprising a dovetail shaped recess 368 arranged for sliding receipt of the dovetail shaped protrusion 362 of the first locking pin portion 360.

To assemble the lateral support 340 to the leg 310, the protrusions 351, 353 of the beam 341 are fitted into the respective slots 352, 356 of the lateral projection 350, until the opening 354 of the lateral projection 350 and the opening 355 of the protrusion 351 of the beam 341 are aligned, and a snug grip has been made between the teeth 357 of the slot 356 and the transverse protrusion 353. The two portions of the locking pin 360, 366 are then slotted in a fitting, snug manner into the openings 354, 355 from opposite directions, i.e. from either side of the lateral projection 350, until the dovetail shaped protrusion 362 of the first portion of the locking pin 360 is received within and engages with the dovetail shaped recess 368 of the second portion of the locking pin 366. This locks the beam 341 and the leg 310 together against relative radial and axial movement and relative rotation.

As seen in FIG. 12A, the locking pin portions 360, 366 may have length arranged so that the locking pin portion 360, 366 lie flush with an outer surface of the lateral projection 350 when fitted into the openings 354, 355. Thus accidental dislocation of the locking pin portions 360, 366 can be prevented.

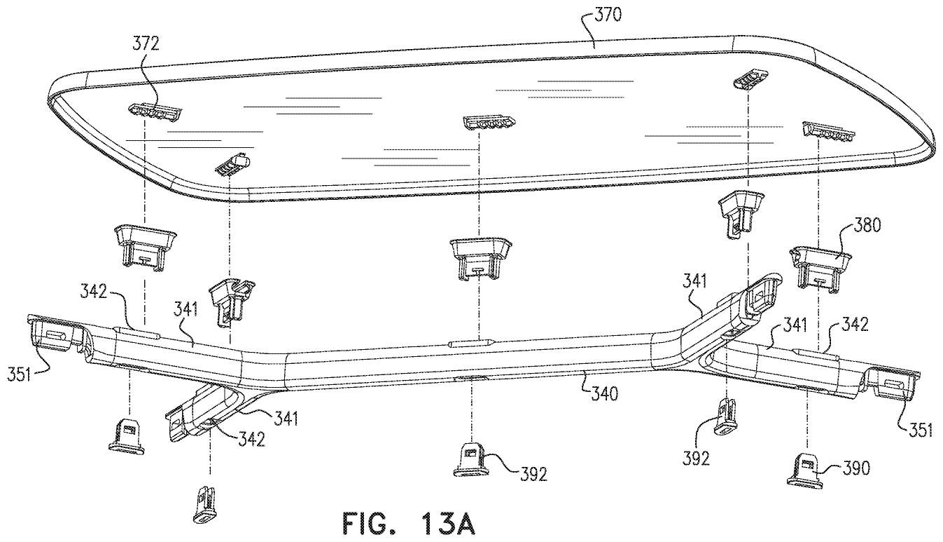

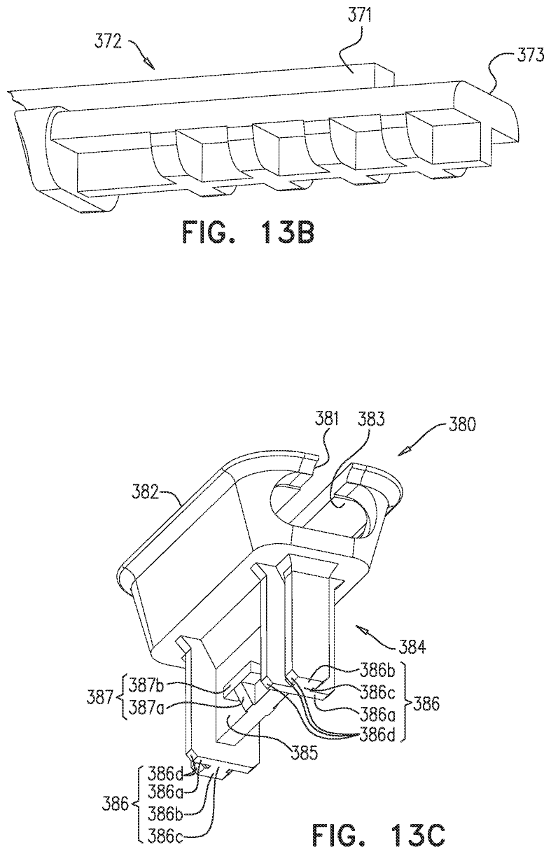

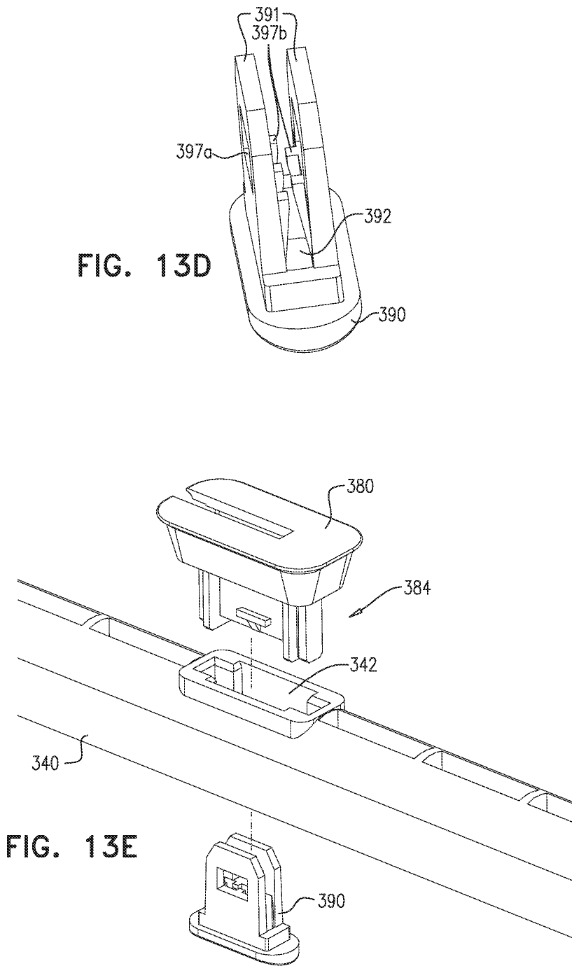

FIGS. 13A-13E depict an exemplary fixing arrangement for fixing a shelf 370 to a lateral support 340. It should be understood that such a fixing arrangement is further applicable to other elements apart from shelves, as long as protrusions for clips (as described below) are provided.

The present example as described in more detail below provides a lateral surface support structure comprising a lateral support 340, configured to be detachably attachable to a plurality of lateral projections 350 of a respective plurality of legs 310 which are vertical support members. The lateral support 340 is provided with predetermined fixing portions, in the form of apertures 342 on shaped beams 341 and a central spar, to which a lateral surface, i.e. shelf 370 can be affixed. Shelf 370 has a plurality of fixing portions, in the form of protrusions 372, arranged on the shelf 370 at predetermined locations corresponding to the apertures 342 on the lateral support 340. The shelf 370 can be attached to, and subsequently detached from, the lateral support 340 by corresponding first and second clips portions 380, 390, described in more detail below.

As shown in FIG. 13A, shelf 370 comprises at its underside five protrusions 372, shown in more detail in FIG. 13B, of which four are located at the sides, i.e. peripheral protrusions and one is located at the center of the underside, i.e. a central protrusion. Each of the protrusions is arranged to engage with a first clip portion 380, which in turn is capable of engaging with an aperture 342 in the lateral support 340. Thus the protrusions 372 are located on the underside of the shelf 370 at positions corresponding to (and directly above, when the shelf 370 is in its fixed position) positions of the apertures 342 on the lateral support 370. As can be seen, one of the protrusions 372 is located above the central spar, while the remaining protrusions 372 are located above a respective one of the forked beams 341.

As seen in FIG. 13B, the peripheral protrusions 372 each comprise a narrower neck portion 371 which is joined to an underside of the shelf 370 and a wider locking portion 373 wider than the neck portion 371. Correspondingly, as shown in FIG. 13C, each first clip portion 380 comprises a narrow aperture 381 to a wider enclosure 383. Each first clip portion 380 is arranged to fit slidingly around one of the peripheral protrusions 372, such that the wider locking portion 373 is received within the wider enclosure 383, and the narrower neck portion 371 passes through the narrow aperture 381. In this manner, the peripheral protrusion 372 holds the first clip portion 380 against the underside of the shelf 370, with a top surface 382 of the first clip portion 380 adjacent to the underside of the shelf 370.

Each first clip portion 380 further comprises a protruding portion 384 protruding away from the top surface 382 towards a lateral support 340 when assembled therewith. The protruding portion 384 has a generally I-shaped cross-section comprising a web 385 having two flanges 386, each flange 386 of the I-shaped cross-section comprising a pseudo I-shaped cross-section having one larger flange 386a, one smaller flange 386b and a web 386c in-between. Each of the flanges 386 comprises a ramped portion 386d at a distal end thereof. Disposed on either side of the web 385 is a snap-fit protrusion 387 comprising a ramp 387a followed by a step 387b.

As shown in FIG. 13D, each second clip portion 390 comprises two parallel protruding cantilever portions 391, each comprising an aperture 397a passing therethrough. On a side of each protruding cantilever portion 391 located in between the two parallel cantilever portions 391 are a plurality of ramp portions 397b.

As shown in FIG. 13E, the lateral support 340 comprises apertures 342 passing therethrough. The apertures 342 have a cross-sectional shape corresponding to, and arranged to receive, the protruding portion 384 of one of the first clip portions 380 and the cantilever portions 391 of one of the second clip portions 390.

In operation, The first clip portions 380 are first attached to the protrusions 372 at the underside of the shelf 370. However, the shelf 370 is not shown in FIG. 13E for clarity. Each first clip portions 380, while attached to an underside of the shelf 370, is inserted into one of the apertures 342 passing through the lateral support 340 from a top side thereof, and each second clip portion 390 is inserted into one of the apertures 342 passing through the lateral support 340 from a bottom side thereof, i.e. from opposite directions, such that the second clip portion 390 is inserted into the aperture 342 from the opposite direction to the first clip portion 380.

As the first and second clip portions 380, 390 are pushed towards one another, the two parallel cantilever portions 391 of the second clip portion 390 move parallel to and on either side of the web 385 of the first clip portion 380. In doing so, the two parallel cantilever portions 391 of the second clip portion 390 of the second clip portion 390 contact and slide over the ramp portions 387a of the first clip portion 380, so that the two parallel cantilever portions 391 of the second clip portion 390 are urged away from one another, i.e. wider apart.

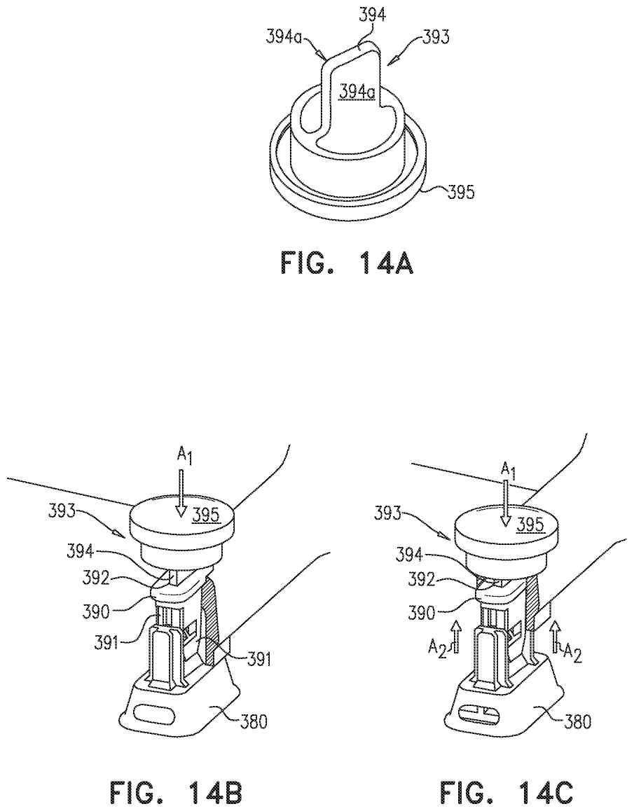

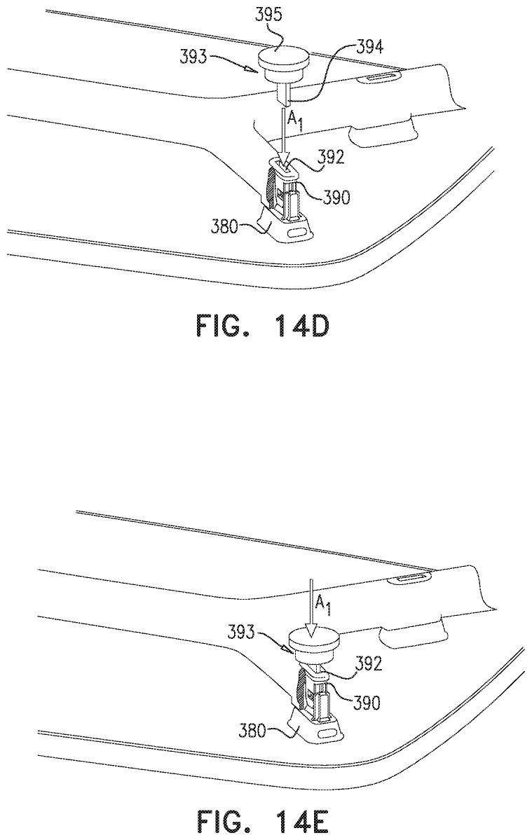

After the first and second clip portions 380, 390 are pushed towards one another to a pre-set extent, the steps 387b will lock inside the apertures 397a causing the two parallel cantilever portions 391 to move back towards one another. This is a snap-fit arrangement, such that the first and second clip portions 380, 390 cannot be disengaged without urging the two cantilever portions 391 apart to release the steps 387b from their respective apertures 397a. The means by which disengagement can occur is described below in further detail, with reference to FIGS. 14A-14E.

As can be seen in FIG. 13A, all of the first clip portions 380 slide into position on the protrusions 372 in a direction parallel to the beam 341 or central spar of respectively of the lateral support 340 at their respective positions and are subsequently placed into an aperture 342 of the lateral support 340 for engagement via their protruding portions 384. Thus, once the shelf 370 is fixed to the beam, the first clip portions 380 are locked against all relative motion and cannot slide out of place.

Although the above described arrangement is shown as having five protrusions on each shelf, it should be understood that any arrangement of protrusions capable of receiving a clip for attachment to a lateral support is envisioned. Furthermore, should the lateral support comprise a different arrangement other than four branched beams extending from a central spar, the arrangement of protrusions on each shelf can be selected to correspond to the shape of the underlying lateral support.

Moreover, although the above describe specific example refers to a shelf 370, it should be understood that a shelf is just one example of a lateral surface which could be fixed in this manner to the lateral support.

FIGS. 14A-14E show an unlocking device, or cap 393, having a protruding portion 394 and a gripping portion 395. The unlocking device 393 can be used for disengaging the first and second clip portions 380, 390 from one another, to enable separation of the first clip portion 380 from the second clip portion 390. As can be seen in FIGS. 13A-13E and 14B-14E, each of the second clip portions 390 comprises a slot 392 passing through an end face of the second clip portion 390, so as to be aligned with the space between the two parallel protruding cantilever portions 391.

The slot 391 is capable of receiving the protruding portion 394 of the unlocking device, such that two opposing side faces 394a of the protruding portion 394 contact the ramp portions 397b of the second clip portion 390, forcing the two parallel protruding cantilever portions 391 to move apart from one another. This allows the steps 387b of the first clip portion 380 to be released, and disengage from the apertures 397a, thereby opening the snap-fit arrangement.

FIG. 14D shows an unlocking device 393 being inserted into a slot 392 of a second clip portion 390 in the direction of the arrow A₁, and FIG. 14E shows the unlocking device 393 being pushed into the slot 392 of the second clip portion 390 in the direction of the arrow A₁. The gripping portion 395 comprises a large flat surface to enable easy pressing of the unlocking device 393 into the slot 392 of the second clip portion 390. FIG. 14B shows an enlarged version from a different perspective of the pushing of the unlocking device 393 shown in FIG. 14E, and FIG. 14C shows the unlocking device 393 being urged deeper into the into the slot 392 by pressing the first clip portion 380 in the direction of arrows A₂, opposite to direction A₁, i.e. by pressing the first and second clip portions 380, 390 towards one another.

Disengagement of the first and second clip portions 380, 390 may be desirable in the event of dismantling a part of the shelving unit, e.g. for structural modifications, replacement of parts such as a broken shelf 370, etc. Structural modifications may include, but are not limited to, amending the configuration of a shelf unit with flexibility, to add or remove further units, shelves or other components above, below, or to the side of the original unit or shelf, for example. Such a flexibility in configuration of the shelf unit allows upgrading or changing the form and/or configuration of the shelf unit over time in a manner desired by a user.

Disengagement of the locking plug arrangement shown in FIGS. 11A-11D, in particular of the first and second locking plug portions 320, 330, maybe performed in an identical manner to that described above for the first and second clip portions 380, 390, by inserting the unlocking device 393 into the slot 335 of the second plug portion 330, such that the two opposing side surfaces 394a of the protruding portion 394 contact the ramp portions 333a of the second plug portion 330, forcing the two parallel protruding cantilever portions 331 to move apart from one another. This allows the steps 323b of the first plug portion 320 to be released, and disengage from the apertures 333b, thereby opening the snap-fit arrangement.

Since this disengagement requires the use of an external tool, namely the unlocking device 393, accidental unlocking can be prevented, since deliberate intervention is required in order to dismantle an otherwise safe, secure and stable arrangement.

Similarly, it may be possible to separate, in a sliding manner, the dovetail shaped connection between the first locking pin portion 360 and the second locking pin portion 366 shown in FIGS. 12A-12E.

1.-44. (canceled)

45. A coupling system comprising:
a first tubular member with a top end and a second tubular member with a bottom end, defining together a longitudinal axis, wherein one of the top end of the first tubular member and the bottom end of the second tubular member is configured with a longitudinal axially extending socket portion, and the other one of the top end of the first tubular member and the bottom end of the second tubular member is configured with a longitudinal axially extending plug portion for coaxial snug receipt within the socket portion; wherein each of the tubular socket portion and the plug portion is configured with a lock opening intersecting the longitudinal axis; and
a locking plug configured for locking engagement of the lock openings while in register with one another, thereby preventing axial or rotary displacement of the first tubular member and the second tubular member.

46. The coupling system of claim 45, wherein at least one of the first and the second tubular members is configured with one or more laterally extending beams, an axis of which intersects a longitudinal axis of the respective at least one of the first and second tubular members.

47. The coupling system of claim 46, wherein the one or more laterally extending beams is oriented to extend along an axis which is at a right angle or inclined with respect to the longitudinal axis of the respective at least one of the first and second tubular members, and/or wherein the one or more laterally extending beams is fixed or detachably attached to the respective at least one of the first and second tubular members.

48. The coupling system of claim 45, wherein in an assembled configuration an external surface of the first tubular member and an external surface of the second tubular member coextend and are flush with one another.

49. The coupling system of claim 45, wherein one of the first tubular member and the second tubular member is configured with a radially inward annular socket shoulder at a base of the tubular socket portion, and the other of the first tubular member and the second tubular member is configured with a radially inward annular plug shoulder at a base of the plug portion.

50. The coupling system of claim 49, wherein (i) the socket shoulder has an annular width substantially the same as the plug shoulder, and/or (ii) wherein in an assembled configuration the socket shoulder bears against the plug shoulder, whereby axial loads between the first tubular member and the second tubular member are transferred.

51. The coupling system of claim 45, wherein the socket portion is a tubular socket portion, and wherein the plug portion is a tubular plug portion for coaxial snug receipt within the tubular socket;
wherein the system further comprises a bored coupling sleeve member configured for coaxially snugly mounting over the tubular socket, the coupling sleeve member being configured with a lock opening intersecting the longitudinal axis; and the locking plug being configured for locking engagement of the lock openings while in register with one another, thereby preventing axial or rotary displacement of the first tubular member, the second tubular member and the coupling sleeve member.

52. The coupling system of claim 51, wherein the coupling sleeve member is configured with one or more laterally extending beams, an axis of which intersects a longitudinal axis of the coupling sleeve member.

53. The coupling system of claim 52, wherein the one or more laterally extending beams is oriented to extend along an axis which is at a right angle or inclined with respect to the longitudinal axis of the coupling sleeve member, and/or wherein the one or more laterally extending beams is fixed or detachably attached to the coupling sleeve member.

54. The coupling system of claim 51, wherein an external diameter of the coupling sleeve member is substantially similar to an external diameter of the second tubular member.

55. The coupling system of claim 51, wherein in an assembled configuration an external surface of the first tubular member, an external surface of the coupling sleeve member and an external surface of the second tubular member coextend and are flush with one another.

56. The coupling system of claim 51, wherein the coupling sleeve member is longer than both the tubular socket portion and the tubular plug portion.

57. The coupling system of claim 51, wherein the first tubular member is configured with a radially inward annular socket shoulder at a base of tubular socket portion, and the second tubular member is configured with a radially inward annular plug shoulder at a base of the tubular plug portion.

58. The coupling system of claim 57, wherein the socket shoulder has an annular width substantially the same as the through-thickness of the coupling sleeve member, and/or wherein the plug shoulder has an annular width substantially the same as the cumulative through-thickness of the coupling sleeve member and annular width of the socket shoulder.

59. The coupling system of claim 51, wherein in an assembled configuration respective ends of the coupling sleeve member bear against the respective socket shoulder and plug shoulder, whereby axial loads between the first tubular member and the second tubular member are borne by the coupling sleeve member.

60. The coupling system of claim 51, wherein an external diameter of the coupling sleeve member is substantially similar to an external diameter of the first tubular member, at least at a portion adjoining the tubular socket.

61. The coupling system of claim 51, wherein an internal diameter of the coupling sleeve member is substantially similar to an external diameter of the tubular socket of the first tubular member.

62. The coupling system of claim 51, wherein the coupling sleeve member is configured with one or more support arms, laterally extending towards an opposite another coupling sleeve member.

63. The coupling system of claim 45, wherein a socket portion and a plug portion disposed at respective ends of a tubular member extend coaxially or along axes which intersect one another.

64. The coupling system of claim 45, wherein the locking plug is snappingly arrested at its locked position, so as to prevent accidental displacement thereof.

65. A structure comprising at least one coupling system of claim 45.
